(19) United States
(12) Patent Application Publication
(10) Pub. No.: US 2024/0104049 A1
(43) Pub. Date: Mar. 28, 2024

(54) OPERATION RESULT BROADCASTING SOLUTIONS FOR PROGRAMMABLE PROCESSING ARRAY ARCHITECTURES

(71) Applicant: Intel Corporation, Santa Clara, CA (US)

(72) Inventors: Erik Rijshouwer, Nuenen (NL); Jeroen Leijten, Hulsel (NL); Bert Schellekens, Hertogenbosch (NL); Zoran Zivkovic, Hertogenbosch (NL)

(21) Appl. No.: 18/529,363

(22) Filed: Dec. 5, 2023

(51) Int. Cl. G06F 15/80; G06F 9/30

(52) U.S. Cl. CPC G06F 15/80; G06F 9/30098

(57) ABSTRACT

Techniques are disclosed for a programmable processor array architecture that enables synchronized broadcasting of operation results to register files with the operation results. The architecture advantageously enables writing of operation results of a given operation to multiple destination registers in a single clock cycle for processors with partitioned register files by using common data stationary instruction encoding. This combination brings improved performance by reducing the need for costly copy operations that would otherwise occupy issue slots and thus schedule space while at the same time minimizing code size overhead. The performance gains of broadcasting are especially emphasized in highly parallel and heavily partitioned register file architectures.

### BACKGROUND

Wireless signal processing requires a high processing load for a very limited power budget, which may be addressed by programmable processing array solutions that provide a scalable and efficient processor architecture. Such solutions, which have been developed to address these processor needs, may be referred to as software-defined radio. In this context, such programmable processing array architectures are designed with a high emphasis on the optimization of resources such as program size and memory. However, current techniques to implement programmable processor arrays within the context of software-defined radio have various drawbacks, particularly with respect to providing adequate code size reduction while maintaining performance benefits and compiler freedom.

### BRIEF DESCRIPTION OF THE DRAWINGS/FIGURES

The accompanying drawings, which are incorporated herein and form a part of the specification, illustrate the aspects of the present disclosure and, together with the description, further serve to explain the principles of the aspects and to enable a person skilled in the pertinent art to make and use the aspects.

FIG. 1 illustrates an example of a conventional vector processor architecture.

FIG. 2 illustrates another example of a conventional vector processor architecture.

FIG. 3 illustrates a block diagram showing details of a portion of a programmable processing array, in accordance with the disclosure;

FIG. 4A illustrates a conventional programmable processing array architecture implementing the use of copying operations to copy operation results;

FIG. 4B illustrates a programmable processing array architecture implementing the use of broadcasting to copy operation results, in accordance with the disclosure;

FIG. 5 illustrates a conventional data stationary encoding (DSE) very large instruction word (VLIW) format;

FIGS. 6A-6C illustrate different instruction formats for encoding broadcast operations, in accordance with the disclosure;

FIG. 7 illustrates part of a programmable processing array architecture, in accordance with the disclosure;

FIG. 8 illustrates a broadcast delay unit, in accordance with the disclosure;

FIG. 9 illustrates a multi-path unit interface, in accordance with the disclosure;

FIGS. 10A-10C illustrates various multi-path unit architectures, in accordance with the disclosure;

FIG. 11A illustrates additional detail with respect to destination index decoder (DIDEC) outputs, in accordance with the disclosure;

FIG. 11B illustrates a signal architecture for translating DIDEC outputs to control signals, in accordance with the disclosure;

FIG. 12 illustrates a result select network architecture to support broadcasts, in accordance with the disclosure;

FIG. 13 illustrates a device, in accordance with one or more aspects of the present disclosure; and

FIG. 14 illustrates a process flow, in accordance with one or more aspects of the present disclosure.

The exemplary aspects of the present disclosure will be described with reference to the accompanying drawings. The drawing in which an element first appears is typically indicated by the leftmost digit(s) in the corresponding reference number.

### DETAILED DESCRIPTION

In the following description, numerous specific details are set forth in order to provide a thorough understanding of the present disclosure. However, it will be apparent to those skilled in the art that the implementations of the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring the disclosure.

The disclosure generally relates to programmable processing array architectures and, in particular, to techniques for using such architectures to perform broadcasting operations in an efficient manner that facilitates code size reduction.

I. Programmable Processing Array Operational Overview

The programmable processing arrays as discussed in further detail herein may be implemented as vector processors or any other suitable type of array processors, of which vector processors are considered a specialized type. Such array processors may represent a central processing unit (CPU) that implements an instruction set containing instructions that operate on one-dimensional arrays of data referred to as data “vectors.” This is in contrast to scalar processors having instructions that operate on single data items. Vector processors can greatly improve performance on certain workloads, notably numerical simulation and similar tasks, by utilizing a number of execution units, which are alternatively referred to herein as cores, processing units, functional units, or processing elements (PEs), and which independently execute specific functions on incoming data streams to achieve a processing flow.

Generally speaking, conventional CPUs manipulate one or two pieces of data at a time. For instance, conventional CPUs may receive an instruction that essentially says “add A to B and put the result in C,” with ‘C’ being an address in memory. Typically, the data is rarely sent in raw form, and is instead “pointed to” via passing an address to a memory location that holds the actual data. Decoding this address and retrieving the data from that particular memory location takes some time, during which a conventional CPU sits idle waiting for the requested data to be retrieved. As CPU speeds have increased, this memory latency has historically become a large impediment to performance.

Thus, to reduce the amount of time consumed by these steps, most modern CPUs use a technique known as instruction pipelining in which the instructions sequentially pass through several sub-units. The first sub-unit reads and decodes the address, the next sub-unit “fetches” the values at those addresses, while the next sub-unit performs the actual mathematical operations. Vector processors take this concept even further. For instance, instead of pipelining just the instructions, vector processors also pipeline the data itself. For example, a vector processor may be fed instructions that indicate not to merely add A to B, but to add all numbers within a specified range of address locations in memory to all of the numbers at another set of address locations in memory. Thus, instead of constantly decoding the instructions and fetching the data needed to complete each one, a vector processor may read a single instruction from memory. This initial instruction is defined in a manner such that the instruction itself indicates that the instruction will be repeatedly executed on another item of data, at an address one increment larger than the last. This allows for significant savings in decoding time.

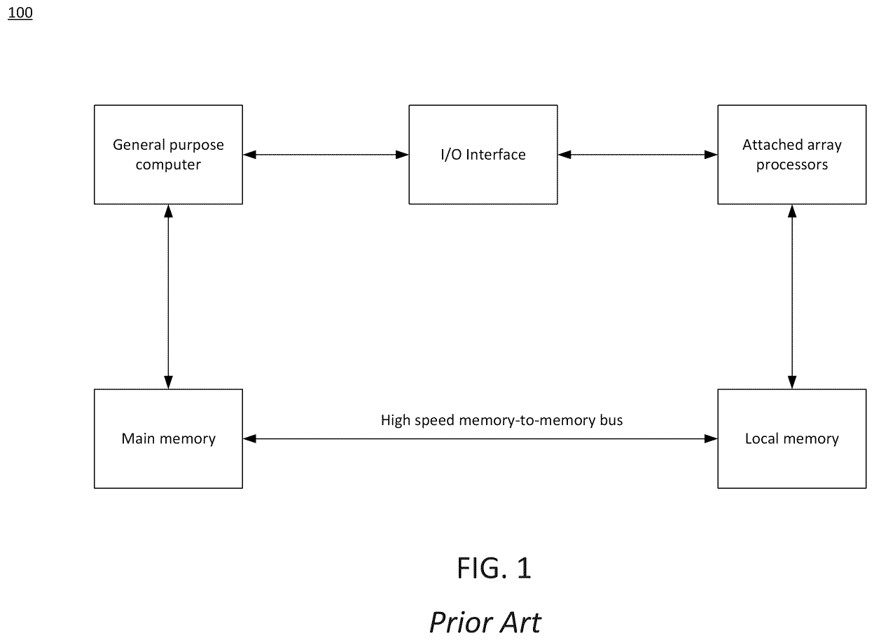

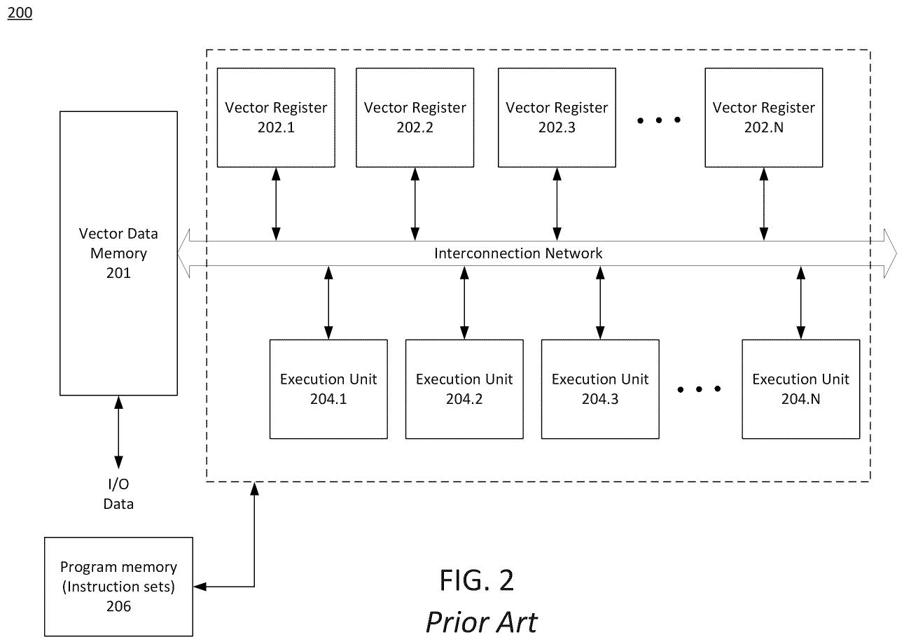

Vector processors may be implemented in accordance with various architectures, and the various programmable array processor architectures as discussed throughout the disclosure as further described herein may be implemented in accordance with any of these architectures or combinations of these architectures, as well as alternative processing array architectures that are different than vector processors. FIGS. 1 and 2 provide two different implementations of a vector processor architecture. FIG. 1 illustrates an attached vector processor, which is attached to a general purpose computer for the purpose of enhancing and improving the performance of that computer in numerical computational tasks. The attached vector processor achieves high performance by means of parallel processing with multiple functional units.

FIG. 2, on the other hand, shows an example of a single instruction stream, multiple data streams (SIMD) vector processor architecture. The vector processor architecture 200 as shown in FIG. 2 may have an architecture consisting of one or more execution units 204.1-204.N. Each execution unit is capable of executing one instruction. Each instruction can be a control, load/store, scalar, or a vector instruction. Therefore, a processor architecture with N execution units 204.1-204.N as shown in FIG. 2 can issue as many as N instructions every clock cycle. The execution units 204.1-204.N function under the control of a common control unit (such as a processor or processing circuitry), thus providing a single instruction stream to control each of the execution units 204.1-204.N. The I/O data as shown in FIG. 2 is typically identified with data communicated between the vector processor 200 and another data source or processor (which may be the common control unit or another processor), depending upon the particular application. The vector data memory 201 thus stores data received as input to be processed by the execution units 204.1-204.N, and data that is output or read from the vector data memory 201 after the data is processed. The vector processor architecture 200 as shown in FIG. 2 is an example of a load-store architecture used by vector processors, which is an instruction set architecture that divides instructions into two categories: memory access (loading and storing data between the vector data memory 201 and the vector registers 202.1-202.N) and the vector processing operations performed by the execution units 204.1-204.N using the data retrieved from and the results stored to the vector registers 202.1-202.N.

Thus, the load-store instruction architecture facilitates data stored in the vector data memory 201 that is to be processed to be loaded into the vector registers 202.1-202.N using load operations, transferred to the execution units 204.1-204.N, processed, written back to the vector registers 202.1-202.N, and then written back to the vector data memory 201 using store operations. The location (address) of the data and the type of processing operation to be performed by each execution unit 204.1-204.N is part of an instruction stored as part of the instruction set in the program memory 206. The movement of data between these various components may be scheduled in accordance with a decoder that accesses the instructions sets from the program memory, which is not shown in further detail in FIG. 2 for purposes of brevity. The interconnection network, which supports the transfer of data amongst the various components of the vector processor architecture 200 as shown in FIG. 2, is generally implemented as a collection of data buses and may be shared among a set of different components, ports, etc. In this way, several execution units 204.1-204.N may write to a single vector register 202, and the data loaded into several vector registers 202.1-202.N may be read by and processed by several of the execution units 204.1-204.N. The use of instruction sets in accordance with the vector processor architecture 200 is generally known, and therefore an additional description of this operation is not provided for purposes of brevity.

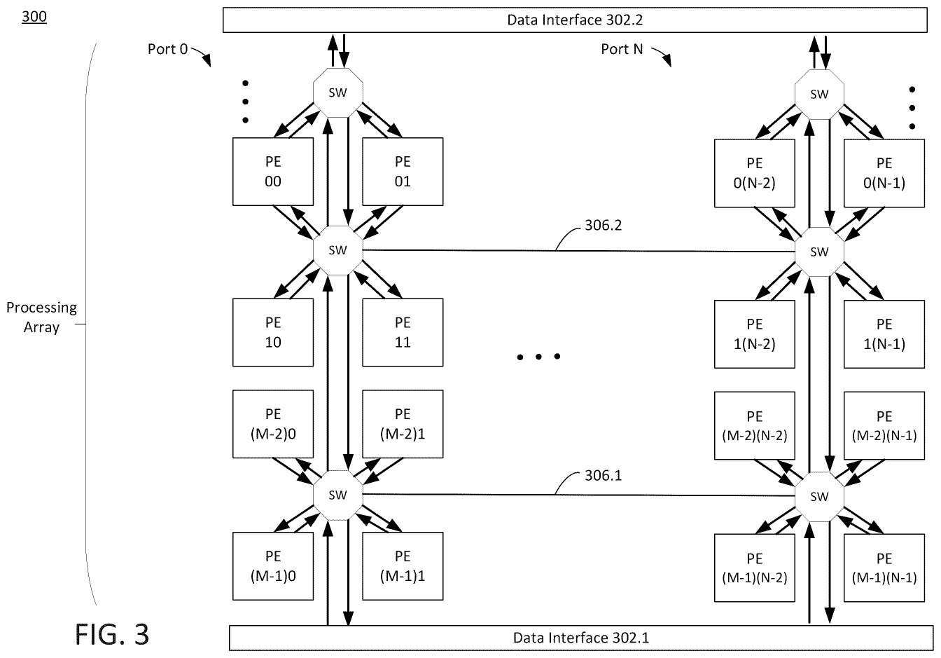

FIG. 3 illustrates a block diagram showing details of a portion of a programmable processing array architecture, in accordance with the disclosure. The portion 300 as shown in FIG. 3 may also be referred to herein simply as a processing array, and may form part of a hybrid architecture that implements dedicated hardware blocks, or as a standalone processing component. In any event, the processing array may include any suitable number N of ports, with each port including any suitable number M of processing elements (PEs). Although each port is shown in FIG. 3 as including 8 PEs, this is for ease of explanation and brevity, and the processing array may include any suitable number of such PEs per port. Thus, the processing array may include a mesh of PEs, the number of which being equal to the number of PEs per port (M) multiplied by the total number of ports (N). Thus, for an illustrative scenario in which the processing array includes 8 ports and 8 PEs per port, the processing array would implement (M×N)=(8×8)=64 PEs. Moreover, in accordance with such a configuration, when implemented to perform wireless processing functions, each port may be identified with a respective antenna that is used as part of a multiple-input multiple-output (MIMO) communication system. Thus, the number of antennas used in accordance with such a system may be equal to the number N of ports, with each port being dedicated to a data stream transmitted and received per antenna.

Each of the PEs in each port of the processing array may be coupled to the data interfaces 302.1, 302.2, and each PE may perform processing operations on an array of data samples retrieved via the data interfaces 302.1, 302.2. The access to the array of data samples included in the PEs may be facilitated by any suitable configuration of switches (SW), as denoted in FIG. 3 via the SW blocks. The switches within each of the ports of the processing array may also be coupled to one another via interconnections 306.1, 306.2, with two being shown in FIG. 3 for the illustrative scenario of each port including 8 PEs. Thus, the interconnections 306.1, 306.2, function to arbitrate the operation and corresponding data flow of each grouping of 4 PEs within each port that are respectively coupled to each local port switch. The flow of data to a particular grouping of PEs and the selection of a particular port may be performed in accordance with any suitable techniques, including known techniques. In one illustrative scenario, this may be controlled by referencing a global system clock or other suitable clock via an system on a chip (SoC), network, system, etc., of which the processing array forms a part.

Thus, at any particular time, one or more of the PEs may be provided with and/or access an array of data samples provided on one of the data buses to perform processing operations, with the results then being provided (i.e. transmitted) onto another respective data bus. In other words, any number and combination of the PEs per port may sequentially or concurrently perform processing operations to provide an array of processed (i.e. output) data samples to another PE or to the data interfaces 302.1, 302.2 via any suitable data bus. The decisions regarding which PEs perform the processing operations may be controlled via operation of the switches, which may include the use of control signals in accordance with any suitable techniques to do so, including known techniques.

The data interfaces 302.1, 302.2 function as “fabric interfaces” to couple the processing array to other components of the architecture in which the processing array is implemented. Thus, the data interfaces 302.1, 302.2 are configured to facilitate the exchange of data between the PEs of the processing array, one or more hardware components such as hardware accelerators, an RF front end, and/or a data source. The data interfaces 302.1, 302.2 may thus be configured to provide data to the processing array that is to be transmitted. The data interfaces 302.1, 302.2 are configured to convert received data samples to arrays of data samples upon which the processing operations are then performed via the PEs of the processing array. The data interfaces 302.1, 302.2 are also configured to reverse this process, i.e. to convert the arrays of data samples back to a block or stream of data samples, as the case may be, which are then provided to one or more hardware components such as hardware accelerators, an RF front end, and/or a data source, etc.

The data interfaces 302.1, 302.2 may represent any suitable number and/or type of data interface that is configured to transfer data samples between any suitable data source and other components of the device in which the processing array is implemented. Thus, the data interfaces 302.1, 302.2 may be implemented as any suitable type of data interface for this purpose, such as a standardized serial interface used by data converters (ADCs and DACs) and logic devices (FPGAs or ASICs), and which may include a JESD-based standard interface and/or a chip-to-chip (C2C) interface. The data samples provided by the data source as shown in FIG. 3 may be in a data array format or provided as streaming (i.e. serial) data bit streams. In the latter case, the data interfaces 302.1, 302.2 may implement any suitable type and/or number of hardware and/or software components, digital logic, etc., to manage the translation of the streams of data bit samples to an array of data samples recognized and implemented via the processing array, and vice-versa.

In one scenario in which the processing array is implemented as part of a wireless communication device, each of the PEs in the processing array may be coupled to the data interfaces 302.1, 302.2 via any suitable number and/or type of data interconnections, which may include wired buses, ports, etc. The data interfaces 302.1, 302.2 may thus be implemented as a collection of data buses that couple each port (which may represent an individual channel or grouping of individual PEs in the processing array) to a data source via a dedicated data bus. Although not shown in detail in the Figures, in accordance with such scenarios each data bus may be adapted for use in a digital front end (DFE) used for wireless communications, and thus the dedicated buses may include a TX and an RX data bus per port in this non-limiting scenario.

II. Very long instruction word (VLIW) instruction set processing architecture overview

Again, programmable processing arrays such as vector processors may implement an instruction set architecture in which instructions are received by the functional units and define the specific operations to be performed by the functional units on arrays of data. As will be discussed in further detail below, the instructions may also identify where the result of the operations may be stored in terms of memory locations referred to herein as register files. For a vector processor architecture, the register files may be identified with the vector registers 202 as shown and described above with respect to FIG. 2.

A VLIW instruction set and accompanying processing architecture enables the exploitation of instruction level parallelism (ILP). For instance, and as noted above, whereas conventional central processing units (CPU, processors) primarily allow programs to specify instructions to execute in sequence only, a VLIW processor allows programs to explicitly specify instructions to execute in parallel. This design is intended to allow higher performance without the complexity inherent in some other designs. To do so, VLIW processor architectures employ what are known as “issue slots” to exploit ILP. An issue slot comprises the operation issue and data path machinery surrounding a set of one or more execution units, which share these resources. This allows a compiler to fully determine the instruction schedule and resource utilization, and ensures that no resource conflicts occur and that all data dependencies are respected. Consequently, the processor architecture is not concerned with any scheduling decisions and can simply execute the operation bundles contained in the VLIW instructions.

III. Time Stationary Encoding (TSE) and Data Stationary Encoding (DSE) Processor Architectures

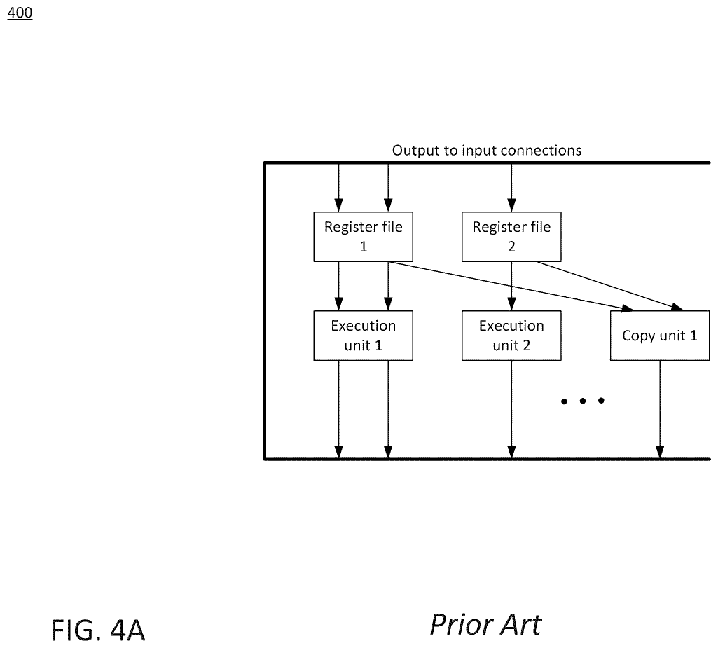

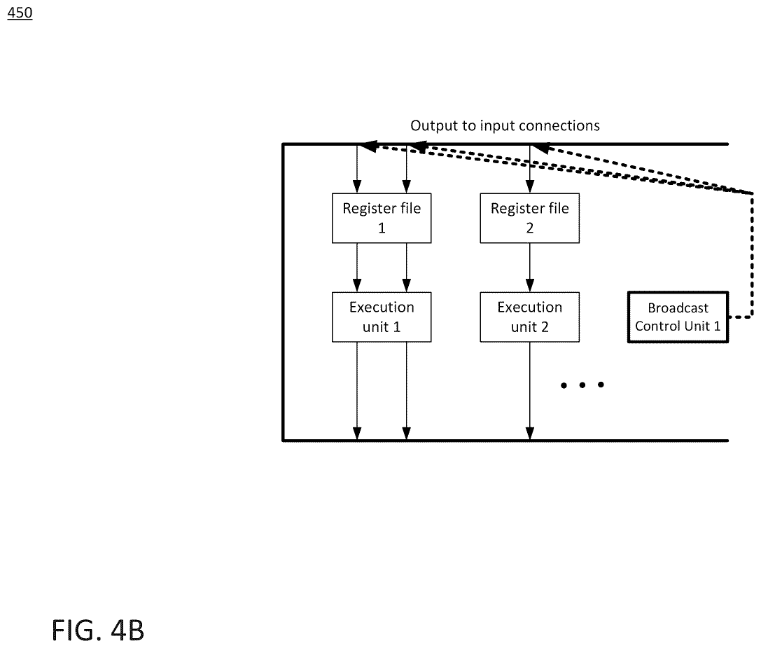

VLIW processor architectures may divide their registers over multiple register files, where each register file may be accessible by a different set of functional units. These so-called partitioned register files have area and power advantages over centralized register files, and allow processors to scale to a large number of parallel issue slots and functional units. However, the fragmentation of registers can lead to situations in which the functional unit producing the data is not sharing a local register file with one or more functional units that must consume that data. Thus, a conventional way resolve this issue is by introducing functional units that serve as a bridge between two partitioned register files. These functional units can copy data from one register file to another by means of special “pass”/“move” operations. The use of a functional unit in this way is shown in FIG. 4A and further discussed below, in which one of the functional units is implemented as a copy unit as shown. However, copying data with the use of such an explicit operation will delay the availability of that data at the target register file(s).

Thus, the broadcasting of operation results may be implemented to manage the copying of data to multiple partitioned register files, albeit without introducing any delay in data availability, as the operation result is written to its broadcast destinations in the same cycle it was produced. However, broadcasting is currently constrained by the topology of the network responsible for routing results from functional units to the register files. Thus, programmable processing array architectures that leverage broadcasting operations utilize a result-routing network architecture implementing one or more data buses to which certain subsets of functional units can write data, and from which certain subsets of register file write ports can receive data.

For instance, in a Time Stationary Encoding (TSE) processor architecture, the processor pipeline is directly controlled by the instruction words, as each instruction word contains the control data for a specific execution cycle. Such an instruction word may specify which operation stage is active on each of the issue slots, which multiplexer settings should be applied to achieve the proper operand routing from and to functional units, and which indices of which register files need to be written to or read from. Thus, all pipeline delays are fully exposed in the instruction schedule. A TSE instruction format is typically of a fixed-length, which results in a significant reduction of the decoding effort as many parts of the pipeline can be directly controlled by the provided instruction word bits. Moreover, as the control bits of different issue slots are read from independent self-contained parts of the instruction word, it is possible to achieve high clock frequencies, especially for VLIW processor architectures that often feature a large number of issue slots.

However, the downside of a fixed-length TSE instruction format is that bits for unused parts of the pipeline are always represented, leading to increased program code size. Several techniques to reduce the code size of TSE have been proposed, which include the use of an offline compression scheme exploiting encoding similarities between consecutive instructions in TSE. But the decoding of instructions compressed in this manner cannot keep up with instruction execution throughput, particularly for more processor-intensive applications. Other techniques involve the definition of multiple instruction set subsets to reduce code size, which trade-off compiler freedom and computing performance for code size. Thus, to date there has not been a practical way to significantly reduce code size in TSE encoding without negatively affecting performance.

Again, a processor architecture can employ buses to broadcast operation results to multiple destinations (e.g. different register files), thereby avoiding the need for explicit pass operations and possibly reducing program execution cycles. A TSE architecture naturally supports such broadcasting, as all that is needed is to configure multiple register files to read from the same bus. Since the control bits for the multiplexers that determine each register file write port which bus it will read from are already present in the instruction word, no changes to the instruction format are required to support broadcasting.

However, in contrast to the fixed-length TSE instruction format, a Data Stationary Encoding (DSE) processor architecture typically has a variable-length instruction format, which is highly beneficial to code size. A DSE instruction provides all operation data at the issue cycle: opcodes, immediate values, operand register file indices, etc. This means that any required pipeline delays of control data due to timeshape delays of operations must be applied by the hardware (e.g. the register file destination index of a multi-cycle load operation must be stored in pipeline registers until it can be used to write the resulting memory value to the register file).

Thus, the broadcasting of operation results is not a natural fit for a DSE processor architecture, as broadcast destinations need to be associated with operation results and the relevant parts of the pipeline (e.g. buses, register files) need to be controlled using the requisite timing. The techniques disclosed in further detail herein propose instruction format and processor architecture enhancements that enable operation result broadcasting for DSE processor architectures. This means that the benefits of TSE with respect to broadcasting may likewise be applied to DSE processor architectures, leading to a solution that offers good code size without sacrificing performance.

The disclosure is described herein primarily in the context of Data Stationary Encoding (DSE) processor architectures with partitioned register files, as such architectures have been proven to provide efficient and scalable programming solutions. However, it is noted that the use of the DSE architecture, as well as the instruction sets as discussed herein, which may comprise a VLIW instruction set architecture, is provided as non-limiting and illustrative scenarios. The techniques described herein may be implemented in accordance with any suitable processor-based architecture and/or instruction sets, which may include alternative processor architectures such as the TSE architecture and/or instruction set architectures other than the DSE and/or VLIW instruction set architecture.

IV. Broadcasting Overview

As noted above, programmable processing array architectures may advantageously implement broadcasting to manage the copying of data to multiple partitioned register files, albeit without introducing any delay in data availability. The term “broadcast registers” refers to a concept in which specific register index values are reserved to access registers with that same index in different register files. For instance, assume a processor architecture having three register files (RFs) RF0, RF1, and RF2, with 16 registers each. A single register would normally be written by providing a combination of a register file identifier and the index of a specific register within that file, e.g. register 3 in RF1. In the case of broadcast registers, a subset of corresponding registers (e.g. register 14 and 15) are reserved across all register files that require broadcasting support. A write of a value to register 14 (or 15) would then automatically result in writing that value to each register 14 (or 15) in all three register files RF0, RF1, and RF2, thereby effectively broadcasting (i.e. copying) the same value to all three register files.

The key limitations of the use of broadcast registers is firstly that broadcasted values can only be written to a limited subset of the dedicated “broadcast registers” in each register file. Secondly, another limitation is that a broadcasted value cannot be written to different register indices in different register files, i.e. they effectively have to be written to the same index in different files. Both of these issues severely limit compiler freedom in effectively using broadcasting, which negatively affects performance.

The solutions proposed in this disclosure do not place any constraints on broadcast destinations other than those already imposed by the result routing network topology. As further discussed herein, the solutions utilize instruction format enhancements and processor pipeline components to associate operation results with broadcast destinations while applying the appropriate pipeline delays. The techniques as further discussed herein enable writing the result of a given operation to multiple destination registers in a single clock cycle for processors with partitioned register files, and utilize common data stationary instruction encoding. This combination brings improved performance by reducing the need for costly copy operations that would otherwise occupy issue slots and schedule space, while at the same time minimizing (or at least reducing) code size overhead. The performance gains of broadcasting are especially emphasized in highly parallel and heavily partitioned register file architectures.

To demonstrate the advantages of broadcasting versus copying of operation results, reference is now made to FIGS. 4A and 4B. Each of the architectures as shown in FIGS. 4A and 4B may be identified with any suitable type of programmable processing array architecture, and each may implement a VLIW instruction set architecture. This may alternatively be referred to herein as a VLIW processor-based architecture. Thus, the register files as shown in FIGS. 4A and 4B may be identified with the vector registers 202 as shown and discussed above with respect to FIG. 2 when the programmable processing array architecture comprises a vector processor architecture. For other architectures, the register files may be implemented as any suitable type of partitioned memory that is configured to store data that is written to and accessed by the various execution units as shown in FIGS. 4A and 4B.

Moreover, the execution units as shown in FIGS. 4A and 4B may be identified with the execution units 204 as shown and discussed above with respect to FIG. 2 when the programmable processing array architecture comprises a vector processor architecture. Alternatively, the execution units as shown in FIGS. 4A and 4B may be implemented as the processing elements (PEs) as shown and discussed above with reference to the programmable processing array portion 300 of FIG. 3. Thus, the output-to-input connections as shown may be identified with part of the interconnection network as shown in FIG. 2 or, alternatively, with the data interfaces 302.1, 302.2 as shown in FIG. 3. These connections enable, in both cases, the operation results output by the execution units, i.e. the data values that may be represented as data arrays, to be stored in any of the vector registers or register files, as the case may be. The output-to-input connections may form part of what is referred to herein as a “write-back network” or, alternatively, “write-back circuitry,” which may comprise interconnected buses and multiplexers that implement control signals to control the flow of data within the programmable processor array architecture. Additional details regarding the use of the write-back circuitry is discussed further below.

Thus, the programmable processing array architecture as shown in FIGS. 4A and 4B may both implement execution units, register files, and input-to-output connections as shown. FIG. 4A illustrates a conventional programmable processing array architecture implementing the use of copying operations to copy and move operation results. For a VLIW processor-based architecture, the copy operations may be used to copy and move values between the registers as shown. However, the use of such copy operations requires that an operation result is first stored in a register file. Then, the copy operation may refer to the stored operation result and copy the operation result to the desired additional destination register.

The use of explicit copy operations to make the operation results available at other destinations has two consequences. First, the copied operation result is available at the destination with a delay of at least a single clock cycle, potentially increasing the critical path of the implemented function. Second, the copy unit (which may comprise an execution unit) will use a register file read port when copying data. This results in the occupation of an existing read port, and may even require read ports to be added to register files.

In contrast, FIG. 4B illustrates a programmable processing array architecture implementing the use of broadcasting to copy and move operation results, in accordance with the disclosure. The programmable processing array 450 as shown in FIG. 4B may implement any suitable number of broadcasting control units, with one being shown in FIG. 4B for purposes of brevity in a non-limiting and illustrative scenario. Compared to the use of the copy unit as shown in FIG. 4A, the use of the broadcasting control unit as shown in FIG. 4B enables a more efficient way of copying the operation result values by broadcasting these values at the time the values are generated. To do so, the broadcast control unit is configured to control the write-back network (i.e. the “output to input connections”) such that operation results may be written to additional destinations that are reachable via the write-back network. The VLIW instruction may be constructed to control which operation results will be broadcast to which destinations by the broadcast control unit, as discussed in further detail below.

The broadcast control unit as shown in FIG. 4B may be implemented as one of the execution units with broadcast/copy operations. Alternatively, in some scenarios the broadcast control unit may be implemented as a dedicated execution unit that only performs broadcast/copy operations with a dedicated control scheme, or a smaller subset of operations compared to the execution units, with the smaller subset of operations including broadcast/copy operations. Thus, in a non-limiting and illustrative scenario, a dedicated execution unit may comprise a dedicated VLIW issue slot that only contains broadcast operations, with an optimized encoding of broadcast sources and destinations.

The techniques as described in further detail herein implement a broadcast control unit comprising a dedicated VLIW issue slot, and cover various alternatives for encoding broadcast operations in this issue slot. However, this description is provided as a non-limiting and illustrative scenario, as the broadcast control unit need not be implemented as a dedicated VLIW issue slot, although doing so may be particularly advantageous in light of a DSE and VLIW architecture. Additional details regarding the broadcasting control unit are further discussed below.

V. Conventional Instruction Encoding

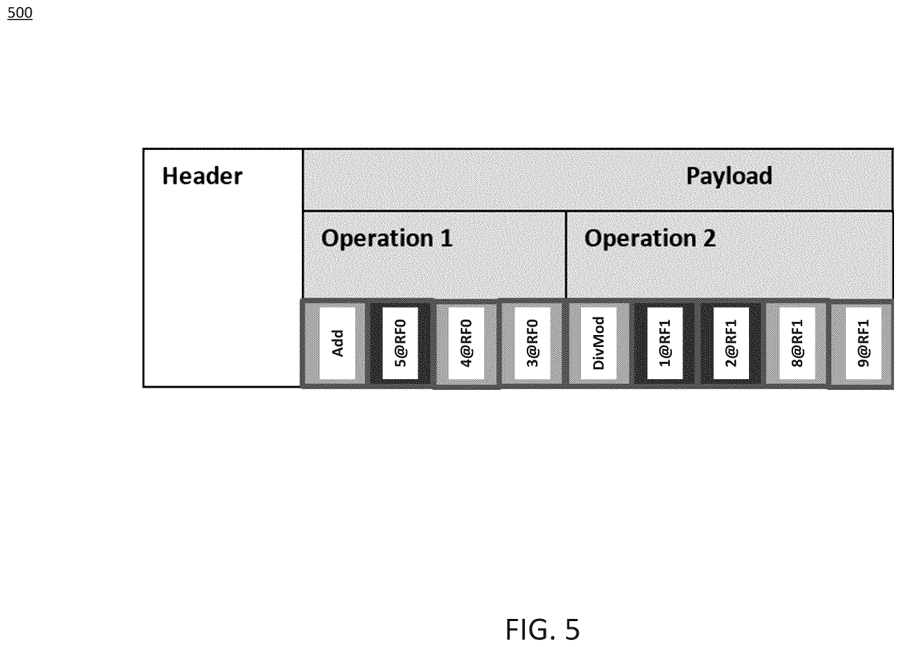

FIG. 5 illustrates a conventional data stationary encoding (DSE) very large instruction word (VLIW) format. As shown in FIG. 5, a variable-length DSE VLIW instruction format comprises a structure that includes a header and a payload. The header structure is often fixed and provides the (minimally) required information for the execution units to extract and decode the operations in its payload. The details for the header are omitted for purposes of brevity. For the example shown in FIG. 5, the payload contains two operations. For Operation 1, the “Add” operation receives arguments from index 4 of register file (RF)0 (i.e. 4@RF0) and index 3 of RF0 (i.e. 3@RF0), and writes its result to index 5 of RF0 (i.e. 5@RF0). Operation 2 implements a “DivMod” operation that produces two outputs (the quotient and the remainder). The DivMod operation reads its inputs from indices 8 and 9 of RF1 and writes its results to indices 1 and 2 of RF1.

Thus, the operation formats used by Operation 1 and Operation 2 allow for the specification of a single destination for each of their results. However, this poses an issue when any operation result values need to be broadcasted to additional destinations (such as additional register files). Further complicating this issue, the required set of broadcast destinations for each operation result is only determined in the context of a program schedule, and there may be many different broadcast destination sets for a given operation format and program schedule. That is, the broadcast destination sets for the schedule of another program may be completely different. This makes it infeasible to cover all possible required broadcast destination combinations with the use of operation formats without severely affecting instruction encoding efficiency and thereby negatively impacting code size.

VI. Encoding Instructions with Broadcasting Operations

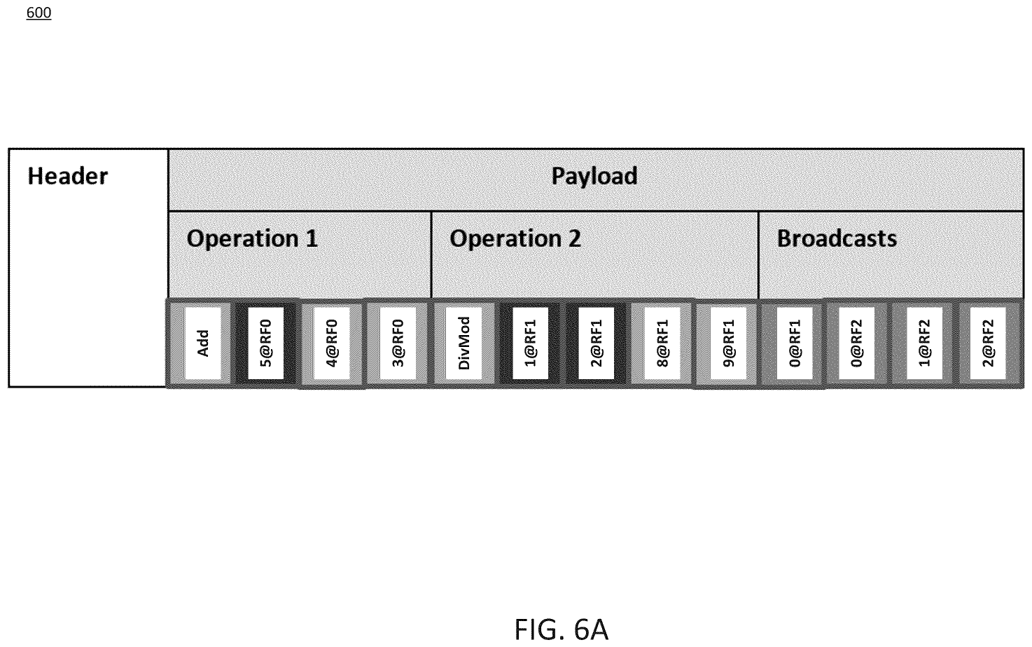

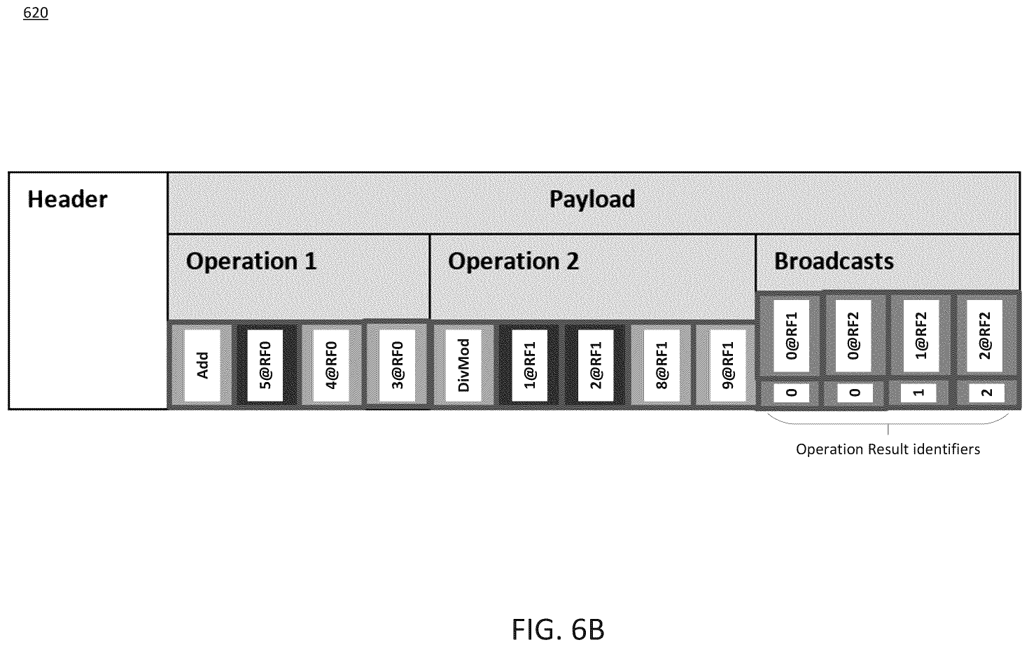

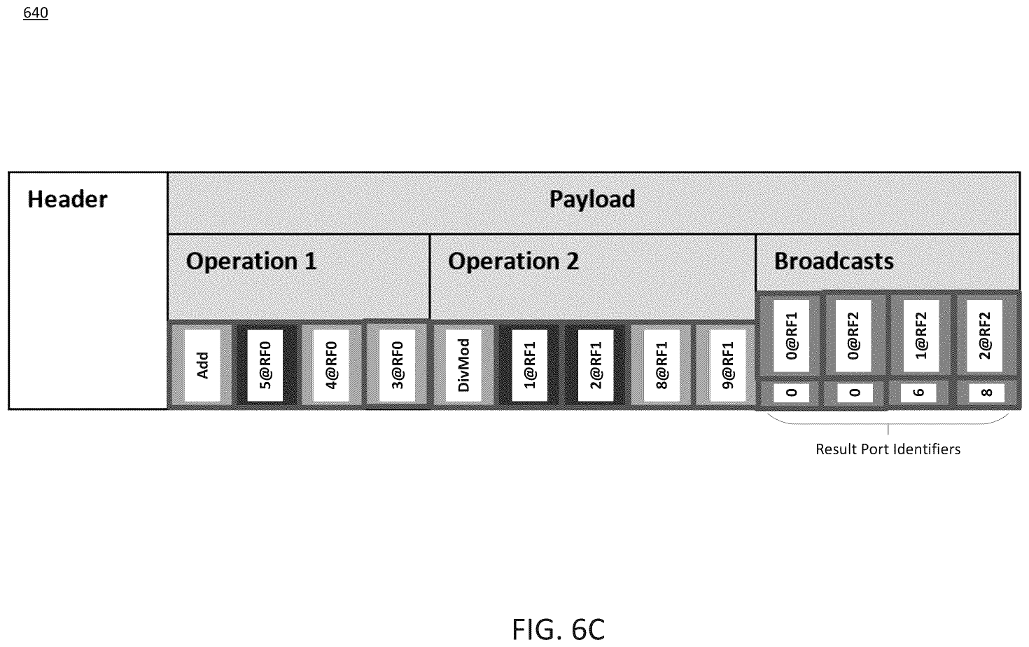

Thus, to address the issues mentioned above with respect to the conventional DSE VLIW instruction encoding structure, the disclosure implements various encodings of the broadcast destinations in an operation-independent form, which are provided as a dedicated section of the payload. That is, the broadcasting operation is defined as part of the payload of the instruction. To this end, FIGS. 6A-6C illustrate different instruction formats for encoding broadcast operations, in accordance with the disclosure.

Each of the encoded instructions as shown in FIGS. 6A-6C comprises and/or complies with a VLIW instruction format, although this is a non-limiting and illustrative scenario. Moreover, the instructions as shown and discussed herein with respect to FIGS. 6A-6C may comply with a VLIW instruction format that is implemented in accordance with a DSE processor architecture. Thus, the programmable processing array architecture as shown in FIG. 4B, which may implement the use of broadcasting to copy and move operation results, may comprise part of a data stationary encoding (DSE) processor architecture in a non-limiting and illustrative scenario. Therefore, the VLIW instruction as discussed in further detail herein may alternatively be referred to as a DSE VLIW instruction.

In contrast to the VLIW instruction as shown in FIG. 5, the VLIW instructions as shown in FIGS. 6A-6C include broadcast operations as part of the payload structure. Although details regarding the header are not shown for purposes of brevity, it will be understood that the header indicates how many broadcast operations are contained in the payload of the current instruction. Thus, the instruction as shown in FIGS. 6A-6C may be considered a DSE VLIW instruction with an additional 4 broadcast operations, which may alternatively be referred to herein as broadcast “slots.” The DSE VLIW instructions as shown in FIGS. 6A-6C are provided as non-limiting and illustrative scenarios and for ease of explanation, and the instructions as discussed herein may be encoded in accordance with any suitable standard of VLIW instruction encoding and/or processor-based architectures, including known techniques to do so.

For each of the encoded instructions as shown in FIGS. 6A-6C, the broadcast portion of the instruction defines an additional destination for one of the operation results of the current instruction. Thus, the result of Operation 1 gets two additional destinations by means of broadcasting: “index 0 of RF1” and “index 0 of RF2.” The first result of Operation 2 gets a broadcast destination “index 1 of RF2,” and the second result of Operation 2 gets a broadcast destination “index 2 of RF2.” In other words, the instruction identifies for each operation to be performed a respective register location from among the registers to store a respective operation result (i.e. 5@RF0, 1@RF1, 2@RF1). Furthermore, by the use of the dedicated broadcast portion of the payload as shown in FIG. 6A, the instruction also identifies one or more respective register locations from among the registers to copy the respective operation result as part of the broadcasting operations (i.e. 0@RF1, 0@RF2, 1@RF2, 2@RF2).

However, and as will be further discussed below, the association of broadcasts and operation results need to be encoded, and each broadcast needs to happen at the right moment when the result is available. Thus, the encoded instructions as shown in FIG. 6A represent the general use of broadcasting operations that form part of the payload of the instruction, although additional information is encoded as part of the broadcasting operations to ensure that the broadcast operations and operation results may be correlated with one another and appropriately synchronized, as further discussed herein.

FIG. 6B illustrates a first option for encoding broadcasts by enumerating the current instruction's results. For the option shown in FIG. 6B, the association of each broadcast operation and an operation result is achieved by encoding a result identifier that is part of each broadcast operation and which uniquely identifies each respective operation result for that particular broadcast operation. In a non-limiting and illustrative scenario, this identifier may be based upon an enumeration of the combined results of the operations issued in the current instruction as shown in FIG. 6B. Thus, for the option as shown in FIG. 6B, the result identifier comprises an operation result identifier.

Thus, for the encoded instructions as shown in FIG. 6B, there are a total of three operation results. The first operation result is the result of Operation 1, which is associated with the two additional destinations as noted above, and thus the operation result identifier “0” is associated with each of these first two broadcasts 0@RF1 and 0@RF2. In other words, the operation result to be stored at index 5 of RF0, which is a result of the add operation, and is to be broadcasted to two other register files, i.e. 0@RF1 and 0@RF2. The second operation result is the first result of the DivMod operation from operation 2, which is to be stored at index 1 of RF1, and is to be broadcasted to index 1@RF2. The third operation result is the second result of the DivMod operation from operation 2, which is to be stored at index 2 of RF1, and is to be broadcasted to index 2@RF2. Thus, the result identifiers “1” and “2” are associated with the first and second results, respectively, from operation 2.

Therefore, in the scenario as shown in FIG. 6B, there are a total of three operation result identifiers to be encoded, which would require a field of two bits to ensure a unique binary code representation of each operation result. Thus, considering only the active results and delays implied by the timeshapes of the associated operations keeps the total number of operation results (i.e. the enumeration) small, this reduces the bits required for encoding, which in turn results in a smaller code size.

However, the downside of an enumeration based on the results of active operations is that the enumeration becomes variable as the number of operation results to be encoded is not known in advance. For instance, three bits would be required to encode the operation result identifiers for eight unique broadcasts, four bits for sixteen unique broadcasts, and so on. As the number of unique broadcasts are dependent on the operations to be performed, which are not known in advance, the number of bits needed to encode the operation result identifiers may change over time. Moreover, for the option as shown in FIG. 6B, the association of broadcasts cannot be determined independently per operation. Furthermore, the number of results that each active operation format provides for the complete VLIW instruction must be considered, and the associated delays need to be derived from the operation selection, which complicates the hardware implementation.

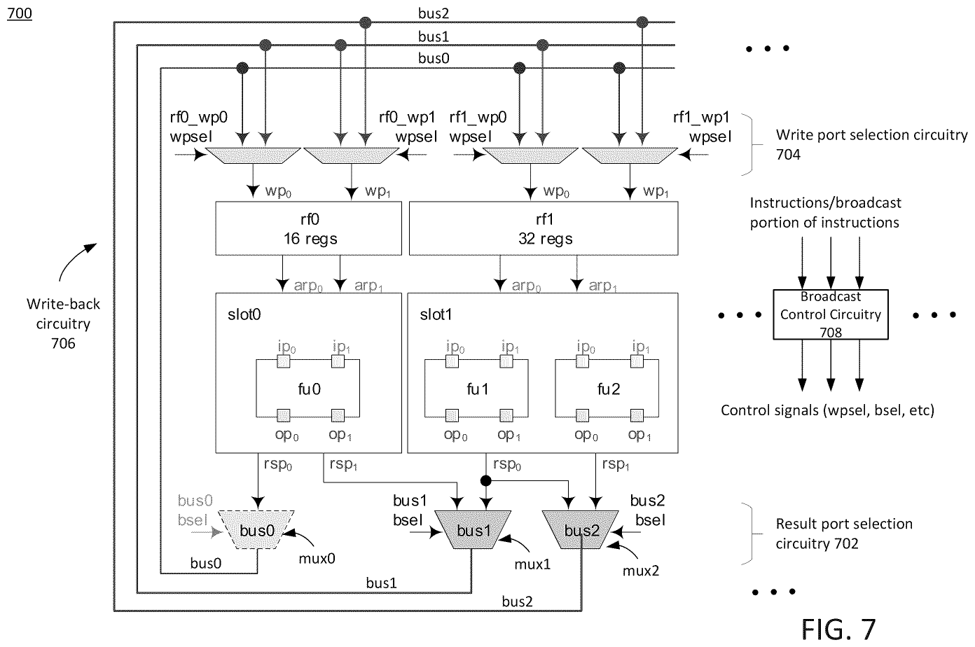

Thus, a second option for encoding the broadcasts includes the use of a portion of the instruction that identifies, for each broadcasting operation, an encoded result port identifier. Thus, for the option as shown in FIG. 6C, the encoded result identifier comprises a result port identifier instead of the operation result identifier as shown in FIG. 6B. In a non-limiting and illustrative scenario, the encoded result port identifier is selected from among a set of result port identifiers that represent all possible combinations of output delays per result port, such that each result port identifier in the enumerated set corresponds to a unique combination of an issue slot, result port, and clock cycle delay. This is discussed in further detail below with respect to the programmable processor array architecture as shown in FIG. 7.

This solution is shown as part of the encoded instructions as shown in FIG. 6C, and assumes that knowledge regarding the hardware architecture of the programmable processing array is known in advance. This information is exploited to obtain an enumeration of every possible combination of result ports and accompanying delays to be broadcasted. That is, each encoded result port identifier represents one of an enumerated set of identifiers that represent an issue slot result port and a corresponding clock cycle delay associated with each respective operation result that may be provided at each respective issue slot result port. In other words, because this enumeration is based on hardware and, in particular, features of the programmable processor array that do not change over time, the enumeration may be used to provide a fixed number of bits for encoding the result port identifier.

For ease of explanation, reference is now made to the programmable processing array 700 as shown in FIG. 7, which may comprise part of a programmable processing array as discussed herein, and may include additional, fewer, or alternate components than those shown in FIG. 7. The programmable processing array 700 may be implemented as any suitable combination of hardware and/or software components, which may comprise part of any suitable platform or system such as an SoC, an application specific integrated circuit, etc.

The programmable processing array 700 may be identified with the programmable processing array 450 as shown and discussed above with respect to FIG. 4B, with the programmable processing array 700 as shown in FIG. 7 providing additional details regarding the write-back circuitry and overall architecture. Therefore, the register files (RF0, RF1), functional units (fu 0, fu 1, fu 2), and broadcast control circuitry 708 as shown in FIG. 7 may be identified with the register files, execution units, and broadcast control unit, respectively, as shown in FIG. 4B. Moreover, the write-back network as shown in FIG. 7 may be identified with the output to input connections as shown in FIG. 4B. Thus, and as noted above for the programmable processing array 450, the programmable processing array 700 may likewise form part of a DSE processor architecture, in accordance with a non-limiting and illustrative scenario.

For purposes of brevity, the programmable processing array 700 is shown with a portion of the components that would typically be present as part of a complete programmable processing array architecture. With continued reference to FIG. 7, the programmable processing array 700 comprises two issue slots (“slot0” and “slot1”) and two register files (“rf0” and “rf1”). Each issue slot comprises two result ports (“rsp0” and “rsp1”), which output the operation result values provided by the active functional unit in the issue slot (i.e. the data output via the output ports op). These results are then routed back to the write ports (“wp0” and “wp1”) of the register files via multiplexers comprising the result port selection circuitry 702 (“bus0”, “bus1”, and “bus2”) as well as the multiplexers comprising the write port selection circuitry 704.

With continued reference to FIG. 7, the programmable processing array 700 also comprises any suitable number of functional units, with three (fu0, fu1, and fu2) being shown in FIG. 7 for purposes of brevity and ease of explanation. Each of the functional units may be identified with any suitable type of processing element that is implemented as part of a processing array architecture, such as the execution units as discussed herein with respect to the vector processor architecture 200 as shown in FIG. 2, the processing elements (PEs) shown and discussed above with respect to FIG. 3, etc. In any event, each of the functional units as shown in FIG. 7 receives an array of data from a register file location via its respectively coupled argument port (arp), issue slot, and input ports (ip), executes one or more processing operations on the data in accordance with the received instruction(s), and then outputs the operation result (i.e. a result value) via its output ports (op), which are then coupled and/or transmitted to the respective result port (rsp) for that functional unit's respective issue slot. The term “argument port” is used in this context as this port provides the operation argument data to the respective issue slot.

The programmable processing array 700 comprises write-back circuitry 706, which facilitates the transfer of the result values output by each issue slot to specific register file locations in accordance with the received instructions. As shown in FIG. 7, the write-back circuitry 706 comprises result port selection circuitry 702 and write port selection circuitry 704, which function to control the flow of data in this manner back to the register files. The trapezoidal-shaped components bus0, bus1, and bus 2 may comprise any suitable type of multiplexers, switches, etc., that form part of the result port selection circuitry 702, each being configured to output one of several inputs based upon received control signals that are provided to each bsel line. Thus, although labeled as “bus0,” “bus1,” and “bus2,” these are designations used for each multiplexer mux0, mux1, and mux2, respectively, in accordance with the bus of the architecture 700 to which the output of each multiplexer is coupled.

Likewise, the write port selection circuitry 704 may comprise any suitable type of multiplexers, switches, etc., and is configured to output one of several inputs based upon received control signals that are provided to each wpsel lines. In this way, the routing of the data that is copied via broadcasting operations is controlled by the “wpsel” and “bsel” signals, which function to route data that is written to specific register file locations via a specific datapath, i.e. a specific combination of slots, result ports, result port selection circuitry 702, write port selection circuitry 704, write ports, and register file indexes (i.e. specific file locations within the register files). Additional details regarding the routing of data within the programmable processing array 700 using these control signals is discussed further below.

In other words, the write-back circuitry 706 may thus comprise the entirety of all combinations of datapaths of the programmable processing array 700 that are implemented to write results from the various result ports to any of the write ports and, in turn, to specific register file locations. Thus, the write-back circuitry 706 comprises the result port selection circuitry 702, the write port selection circuitry 704, as well as the multiplexers, buses, and/or interconnections between these components. The write-back circuitry 706 may comprise any suitable number of buses, wires, interconnections, etc., that connect the result ports to the result port selection circuitry 702, the connections between the result port selection circuitry 702 and the write port selection circuitry 704, and the connections between the write port selection circuitry 704 and the register files. Thus, the arrows and lines as shown in FIG. 7 that constitute these connections may form at least part of the write-back circuitry 706 as discussed herein.

The programmable processing array 700 also comprises broadcast control circuitry 708, which is configured to receive the same instructions that are transmitted to the functional units or, alternatively, a subset of these instructions as noted above. Thus, the broadcast control circuitry 708 may be implemented as any suitable number and/or type of hardware components, software elements, or combinations of these to enable the various functions as further discussed herein. Again, the broadcast control circuitry 708 may be configured as a dedicated functional unit that only receives the broadcast portion of the payload of each instruction. Alternatively, the broadcast control circuitry 708 may receive the entire instruction and be configured to only utilize the broadcast operation portion of the payload of the instruction. Although a single broadcast control circuitry is shown in FIG. 7, it is also noted that the programmable processing array 700 may comprise any suitable number of broadcast control circuitries, each being dedicated to one or more of the issue slots, functional units, etc. In any event, the broadcast control circuitry 708 is configured to receive the instructions (or a portion thereof) in parallel with the functional units, and to generate the control signals as noted herein to regulate the flow of data within the write-back circuitry 706. The regulation of the data flow in this manner ensures that the broadcasted results are written to register files at the appropriate time, which may be synchronized with the writing of the operation results, as further discussed herein.

With respect to the encoded result port identifiers as shown in FIG. 6C, for the programmable processing array 700, it is assumed for ease of explanation that the functional units fu0, fu1, and fu2 require between 0 to 3 clock cycles to produce the results of an operation. Since functional units within a single issue slot may have an overlapping execution of operations and produce result values on the same result port in an arbitrary order, this implies that the same result port may produce results from different operations with different result delays. Hence, this delay needs to be taken into account to obtain a unique result port identifier for each specific operation result to be broadcast.

To provide an illustrative and non-limiting scenario with respect to the programmable processing array 700 as shown in FIG. 7, knowledge of the hardware and the set of instructions that are used for the programmable processing array 700 may be leveraged to encode the result port identifiers. Specifically, the delay in terms of clock cycles for data provided at each result port for every type of operation to be executed by the functional units fu0, fu1, and fu2 may be determined. Table 1 below summarizes the assumed unique output delays for all result ports for the programmable processing array 700 as follows:

TABLE 1

| Result Port | Unique output delays |
|---|---|
| s0/rsp0 | 0, 2, 3 |
| s0/rsp1 | 1, 2 |
| s1/rsp0 | 0, 3 |
| s1/rsp1 | 0, 3 |

Thus, fu0 may output results at issue slot 0 at either of the result ports rsp0 or rsp1, which may have a different clock cycle delay per port based upon the hardware configuration. Results output at slot 0, result port rsp0 may have a clock cycle delay of 0, 2, or 3, whereas results output at slot 0, result port rsp1 may have a clock cycle delay of 1 or 2. Additionally, fu1 and fu2 may output results at issue slot 1 at either of the result ports rsp0 or rsp1, which may have a different clock cycle delay per port based upon the hardware configuration. Thus, results output at slot 1, result port rsp0 and result port rsp1 may both have a clock cycle delay of 0 or 3. It is thus assumed that no other clock cycle delays are possible from the hardware architecture and operations that are to be performed.

The enumeration based on issue slot result ports and delay combinations, which comprise nine in total, are thus represented as follows:
0→slot0/rsp0/delay_0
1→slot0/rsp0/delay_2
2→slot0/rsp0/delay_3
3→slot0/rsp1/delay_1
4→slot0/rsp1/delay_2
5→slot1/rsp0/delay_0
6→slot1/rsp0/delay_3
7→slot1/rsp1/delay_0
8→slot1/rsp1/delay_3

The encoded instruction as shown in FIG. 6C uses one of these selected enumerated encoded result port identifiers for each broadcast to allow for the correlation of broadcasted results to the results that are provided at a specific result port and with a specific clock cycle delay. Thus, and with reference to FIG. 6C, the results of operation 1 are to be broadcasted to a destination register file 0@RF1 using the result provided at issue slot0, result port rsp0, and with a delay of 0 clock cycles (i.e. result port identifier 0), as well as to another destination register file 0@RF2 using the result provided at issue slot0, result port rsp0, and with a delay of 0 clock cycles (i.e. result port identifier 0). The first result of operation 2 is broadcasted to its destination register file 1@RF2 using the result provided at issue slot1, result port rsp0, with a delay of 3 clock cycles (i.e. result port identifier 6). And the second result of operation 2 is broadcasted to its destination register file 2@RF2 using the result provided at issue slot1, result port rsp1, with a delay of 3 clock cycles (i.e. result port identifier 8). In this way, a fixed encoding scheme (4 bits in this example) may be implemented to encode the result port identifiers, which are not dependent upon the operation results (as was the case for the broadcast encoding in FIG. 6B), but are instead correlated with the datapath within the write-back circuitry 706 at which each result is to be provided via the functional units, as well as the clock cycle delay needed to provide each operation result.

For either of the instructions as shown in FIG. 6B or 6C, the broadcast portion of the instruction may further comprise an encoded result destination identifier. As will be further discussed below, the encoded result destination identifier may form part of and/or be derived from the broadcast portion of the instruction that is associated with register file locations to which the operation results are to be copied as part of each broadcast operation (i.e. each broadcast “slot”). Thus, the locations 0@RF1, 0@RF2, 1@RF2, and 2@RF2 as shown in FIG. 6C may represent any suitable type of encoding, format, logic, code, etc., that constitutes a portion of or the entirety of a result destination identifier. This result destination identifier uniquely identifies a datapath within the write-back circuitry 706 that is to be used to copy each respective operation result provided via the one or more execution units in accordance with each respective broadcasting operation. In other words, the encoded result destination identifier defines a unique datapath within the write-back circuitry 706 that is to be used to copy each respective operation result provided via the one or more execution units in accordance with each broadcasting operation.

In a non-limiting and illustrative scenario, and as further discussed below, the encoded result destination identifier may comprise a destination index that is selected from among a generated enumerated list of result destination identifiers. The enumerated list of result destination identifiers may represent all possible combinations of routes within the datapath of the write-back circuitry 706 that may be used to copy the operation results from a specific result port to a specific register file location in accordance with each broadcast operation. In this way, the destination index may also identify not only the datapath used to copy an operation result, but also the respective register location from among the registers where each operation result is to be copied in accordance with each broadcasting operation.

To provide an illustrative and non-limiting scenario, the destination index may represent one of an enumerated list of all possible combinations of datapaths between the output of each issue slot and all reachable register file locations from among the registers where the result data is to be copied via the broadcast operation (e.g. 0@RF0, 0@RF1, 1@RF0, 2@RF0, etc.). Thus, and with continued reference to FIG. 7, all possible combinations of each of the issue slots, result ports (rsp), the multiplexers that form the result port selection circuitry 702, the multiplexers that form the write port selection circuitry 704, the write ports (wp), and the various registers of register files RF0 and RF1, would form an exhaustive enumerated destination index list. This is facilitated via each issue slot result port having its own exhaustive enumerated destination index list. This list is specific to each issue slot result port per its respective result port selection circuitry 702, write port selection circuitry 704 that is associated with the connected buses, and the register file locations in all connected register files. In other words, this enumerated destination index list represents all possible datapaths for a given issue slot result port within the write-back circuitry 706 from which the operation results of the functional units fu0, fu1, and fu2 may be routed from and written to a specific register file location from among the possible 48 register file locations. Thus, each destination index may comprise a unique index value that is correlated to a unique datapath within the write-back circuitry 706, which is discussed in further detail below. Thus, the use of an encoded result port identifier and an encoded result destination identifier from a constant enumeration allows for a simplified hardware implementation.

VII. Broadcast Control Components—Broadcast Delay Unit

The programmable processing array 700 as shown in FIG. 7 uses the write-back circuitry 706 and the generated control signals to apply the appropriate pipeline delays to the provided destination indexes, such that the copied (i.e. broadcasted) results are made available to the register files simultaneously with the corresponding data (i.e. the operation results). However, the programmable processing array 700 may delay the writing of the operation results to a specific destination register (e.g. 5@RF0, 1@RF1, 2@RF1), and thus also delays the broadcasting of this same operation result data to one or more different destination registers (e.g. 0@RF1, 0@RF2, 1@RF2, 2@RF2). The programmable processing array 700 may delay the writing of the operation results in this manner to a specific destination register in accordance with any suitable techniques, including known techniques. Such delays may comprise pipeline delays and/or stalling scenarios that delay the writeback of results, and the use of such delays are further discussed herein.

However, the required delay for a given broadcast destination depends on the associated operation result, as different operation results may require a different number of clock cycles to complete via respective execution units. Again, it is noted that the enumerated result port identifiers (rspid) encode for this delay, and represent a combination of the result port and respective clock cycle delay. Each result port identifier may therefore represent a combination of a specific result port and delay in accordance with the selected one of the enumerated encoded result port identifiers as noted above. The result port identifier of each broadcast may thus be used to obtain the required delay for which to perform broadcasting of the operation results. That is, and to provide an illustrative and non-limiting scenario, the broadcasts 0@RF1 and 0@RF2as shown in FIG. 6C are associated with the enumerated encoded result port identifiers 0, which identifies the result port rsp0 and a delay of 0 clock cycles. Moreover, and as noted above, the instruction may also comprise or otherwise include information that may be decoded to provide a destination index (ddix) per broadcast operation.

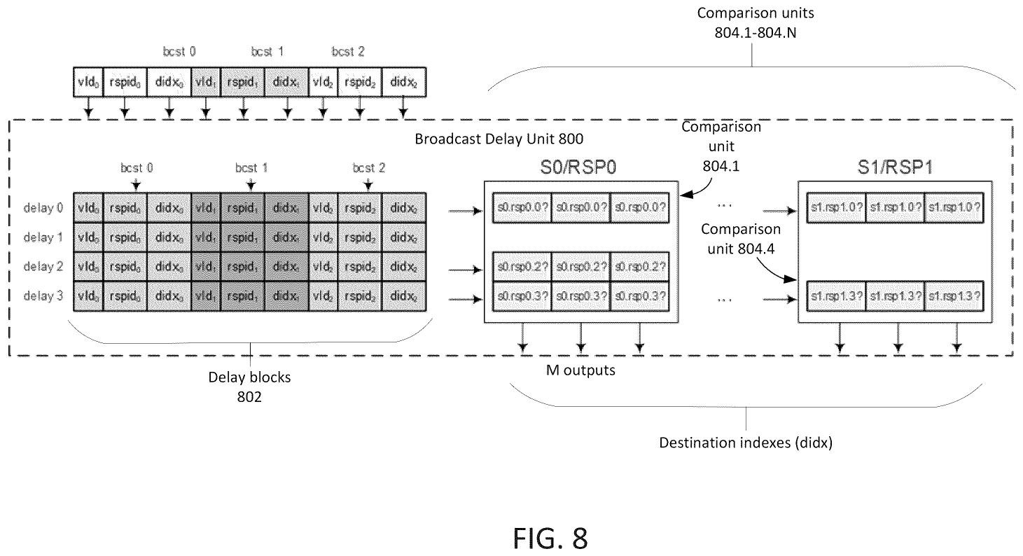

Thus, to ensure synchronization of the broadcasted operation results with the delivery of the corresponding operation results data, the programmable processing array 700 may comprise a broadcast delay unit 800, which is shown in FIG. 8 in accordance with the disclosure. The broadcast delay unit 800 may form part of the broadcast control circuitry 708 as shown and discussed above with respect to FIG. 7. Again, each of the functional units as shown in FIG. 7 is configured to perform, in accordance with a received instruction, one or more processing operations on data accessed from the plurality of register files to provide operation results. As further discussed below, the broadcast control circuitry 708 is configured to generate control signals. These control signals function to control a flow of data within the write-back circuitry 706, which facilitates the storage of data arrays of the operation results to their operation destinations as well as the copying of one or more operation results provided by the one or more of the execution units to one or more register file locations in accordance with one or more broadcasting operations defined via the instruction.

Thus, the broadcast control circuitry 708 may comprise the broadcast delay unit 800 as shown in FIG. 8, which is configured to delay the broadcasts of the operational results provided by the execution units to synchronize with the operational results being written to the register files. Again, the broadcast delay unit 800 may function in a transparent manner with respect to the functional units and, in conjunction with the multi-path unit as discussed in further detail below, generate the control signals. Again, these control signals function to control components of the write-back circuitry 706 to facilitate the routing and storage (i.e. for the operation results as well as copying of the operation results) provided by the execution units to the register files at the appropriate times, as discussed in further detail herein.

To do so, the broadcast delay unit 800 receives the “broadcasts” field of the current instruction. Using this information, the broadcast delay unit 800 identifies the result port delay ID (“rspid”) and destination index (“didx”) for each broadcast as noted above. Although not shown in FIG. 8 for purposes of brevity, further decoding of data contained in the instruction may be performed to provide the rspid and/or didx data to the broadcast delay unit 800 as shown in FIG. 8. For instance, additional logic, decoding, and/or other steps may be implemented to determine the destination index from the encoded result destination identifier are not shown for purposes of brevity, but may be performed in accordance with any suitable techniques, including known techniques. To provide a non-limiting and illustrative scenario, this decoding may comprise the use of the header of the instruction to specify how many broadcast slots are active for a particular instruction, with the minimum being zero up to the maximum number (three in this scenario, although four are shown in FIGS. 6A-6C). For such a scenario, a total of two bits would be needed to identify, per instruction, the number of broadcast slots that are to be used and are valid.

The instruction may also include additional encoded information (not shown) that identifies rspid and didx pairs for each broadcast slot, which are then decoded and used to determine, for each possible broadcast slot, whether the broadcast slot contains valid data that needs to be copied to a register file location or, alternatively, may be ignored. Thus, for each broadcast slot, the broadcast delay unit 800 also receives a validity indicator, abbreviated herein as “vld,” as shown in FIG. 8. In a non-limiting and illustrative scenario, the validity indicator may represent a single one-bit binary representation that identifies whether each broadcast slot contains valid data.

The configuration as shown in FIG. 8 is assumed to support a maximum of three broadcasts per instruction, although this is a non-limiting and illustrative scenario, and the architecture as discussed herein may support any suitable number of broadcasts per instruction. The maximum number of broadcasts per instruction may be greater than or less than three, recognizing trade-offs in cost and hardware complexity with the support of increasing broadcast operations per instruction.

The broadcast delay unit 800 comprises a set of delay blocks 802, which may alternatively be referred to herein as delay circuitry, and which receive the “rspid” and “didx” values for each broadcast (i.e. each broadcast slot, with three being shown), and keep track of the validity of each broadcast via the validity indicators “vld.” Each row of the set of delay blocks 802 represents a specific clock cycle delay, and thus the total number of rows of the delay blocks 802 may be equal to the maximum number of enumerated delays that are possible based upon the particular architecture that is implemented for the programmable processing array 700. Therefore, for the current non-limiting and illustrative scenario, the set of delay blocks 802 comprises four rows, each being identified with a respective clock cycle delay of 0, 1, 2, and 3, which correspond to the delays that are encoded as part of the result port identifiers as noted above.

With respect to the delay blocks 802, it is noted that for each (active) clock cycle, the valid contents of a row are transferred and stored to the row below it. In this way, the clock cycle delay is achieved by relying upon the same number of clock cycles required to transfer the contents of each broadcast to the subsequent row of delay blocks. Thus, each row of the set of delay blocks 802 may be implemented differently based upon the respective clock cycle delay each row represents. As a non-limiting and illustrative scenario, the first row of delay blocks (i.e. “delay 0”) may be implemented as fully combinatorial logic that is configured to transfer the contents for each broadcast slot to a respective comparison unit 804, as further discussed below, with no delay or with only minimal delay. The subsequent rows of the delay blocks 802, however, may be implemented as any suitable type of memory, such as registers, which are configured to store the contents of data (i.e. the vld, rspid, and didx values) for each broadcast slot per clock cycle. Thus, and with continued reference to FIG. 8, for each broadcast slot that is received by the broadcast delay unit 800, the data is maintained in a row of the delay blocks 802 until the expiration of the respective delay, at which time the contents (i.e. the vld, rspid, and didx values) of the delay blocks 802 are provided to the comparator units 804. Again, for the first row, the use of combinatorial logic may ensure that the contents are immediately available without delay (excepting for design tolerances).

The broadcast delay unit 800 also comprises N number of comparison units 804.1-804.N, which may alternatively be referred to herein as comparison circuitry. The number N is equal to the total number of result ports in accordance with the programmable processing array architecture, with four being implemented in accordance with the non-limiting and illustrative scenario for the programmable processing array 700 as shown in FIG. 7. That is, for this scenario, the programmable processing array 700 comprises a total of four result ports (rsp), with two being identified with slot0 and another two being identified with slot1. Thus, the broadcast delay unit 800 in this scenario would comprise a total of four comparison blocks 804.1-804.4, with two being shown in FIG. 8 for purposes of brevity. The two comparison blocks as shown in FIG. 8 correspond to the result port 0 of slot0 and the result port 1 of slot1, respectively, as shown in FIG. 7, i.e. the “first” and “last” of the result ports as shown in FIG. 7.

The delay circuitry 802 is configured to transfer data for each broadcast slot, i.e. the vld, rspid, and didx values, to each comparison unit 804 in accordance with a corresponding clock cycle delay for that particular broadcast slot. In other words, the delay circuitry 802 is configured to output, for each one of the one or more broadcasting operations, a respective validity indicator (vld), result port identifier (rspid), and destination index (didx) at a corresponding clock cycle delay associated with the respective operation result to be copied.

Each comparison unit 804.1-804.4 may be configured as any suitable number of registers and/or logic that is configured to determine, for the data per each broadcast slot that is transferred in this manner with the corresponding clock cycle delay, whether the result port id (rspid) for that particular broadcast matches a predetermined result port id and clock cycle delay. To do so, each comparison unit 804.1-804.4 comprises a set of rows having a respective set of comparison logic that corresponds to a unique predetermined issue slot result port and predetermined clock cycle delay combination. Again, this information is identified as part of the result port identifier, which encodes a combination of the result port and respective clock cycle delay. Thus, each of the comparison units 804.1-804.4 comprises a row that checks whether the data for a broadcast slot, which is transferred at the appropriate clock cycle delay from the delay blocks 802, matches the combination of the issue slot result port and clock cycle delay for that row.

To do so, each of the comparison units 804.1-804.4 comprises a number of rows that represent, for each respective issue slot result port of the programmable processing array 700 as shown in FIG. 7, comparison circuitry that compares the data obtained via the rspid to a predetermined combination of the issue slot result port and respective clock cycle delay for a particular broadcast slot. Thus, it is noted that the rows for the comparison block 804.1 comprise the combination of the slot 0, result port 0, and clock cycle delays of 0, 2, and 3, respectively. The rows for the comparison block 804.4 comprise the combination of the slot 1, result port 1, and clock cycle delays of 0 and 3, respectively. These combinations match those identified above for the enumerated encoded result port identifiers included in the broadcast portion of the instruction as shown in FIG. 6C. That is, based upon the hardware used for the programmable processing array 700 and the predetermined instruction set, there are no operations output at slot0, rsp0 having a clock cycle delay of 1, and likewise for slot1, rsp1, there are no operations output having a clock cycle delay of 1 or 2, as noted above.

To provide an illustrative and non-limiting scenario, using the rspid, each row of the comparison unit 804.1 checks whether the data transferred from the delay blocks 802 matches slot 0, result port 0, and the corresponding clock cycle delay of 0, 2, or 3, as shown. If this is the case, the comparison unit 804.1 outputs a destination index value at the appropriate clock cycle delay time, which is then used to generate the control signals in conjunction with a multipath unit, as discussed in further detail below.

Each comparison unit 804.1-804.4 also provides a number M of outputs, with M corresponding to the maximum number of broadcast slots per instruction, with three being implemented in accordance with the non-limiting and illustrative scenario for the broadcast delay unit 800 as shown in FIG. 8. Thus, the broadcast delay unit 800 is configured to output a number of destination indexes, with one per result port and broadcast slot combination. However, it is noted that it is possible that all broadcast slots at one time may correspond to the same result port. To provide an illustrative and non-limiting scenario, each broadcast slot may correspond to the slot and result port combination identified with the comparison unit 804.1, with the comparison unit 804.4, etc. Therefore, in a non-liming and illustrative scenario, the broadcast delay unit 800 as shown in FIG. 8 may provide, for each of the comparison units 804.1-804.4, a number of destination index outputs M equal to the maximum number of supported broadcast slots per instruction. In this way, the broadcast delay unit 800 may comprise a number of destination index outputs equal to M×N, or 12 for the present non-limiting and illustrative scenario.

VIII. Broadcast Control Components—Multi-Path Unit

As noted above, the programmable processing array architecture as discussed herein functions to write operation results to register file locations, as well as to copy one or more of the operation results to other register files via broadcasting operations. Thus, the broadcast control circuitry as shown in FIG. 4B is configured to generate control signals that control the flow of data within the programmable processing array 700. This ensures that the operation results and the copied (i.e. broadcasted) operation results are written to the correct register files at the correct times, accounting for the clock cycle delays as noted herein.

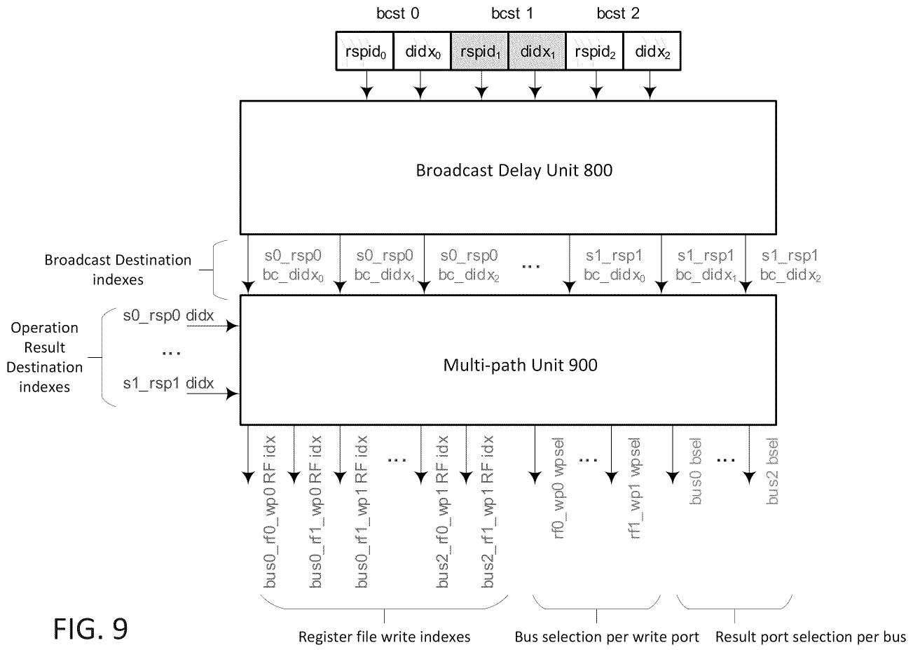

Thus, in addition to the broadcast delay unit as shown in FIG. 8, the broadcast control circuitry 708 as shown in FIG. 7 also comprises a multi-path unit (MPU) 900, with the multi-path unit interface between the broadcast delay unit 800 and the multi-path unit 900 being shown in further detail in FIG. 9. The multi-path unit 900 is configured to combine the regular operation destinations (i.e. the operation results) with the broadcast destinations (i.e. the copied operation results) to provide the wpsel and bsel control signals as shown in FIG. 7. Again, these control signals function to control the multiplexers that form part of the result port selection circuitry 702 and the write port selection circuitry 704. The use of these control signals enables the broadcast control circuitry as shown in FIG. 4B to control the flow of data for both regular (i.e. non-broadcast operations) as well as broadcasting (i.e. copying) operations within the programmable processing array 700, as discussed in further detail herein.

The broadcast delay unit 800 outputs the destination indexes didx, which may be alternatively referred to herein as broadcast destination indexes, at the appropriate clock-cycle delay-adjusted times by the comparison units 804 as shown and discussed above with respect to FIG. 8. Thus, for the scenario as described above, the broadcast delay unit 800 may output a total of 12 destination indexes, with one being output per broadcast and per slot result port, with a maximum of three simultaneous outputs for this particular scenario. Moreover, for each instruction, the operation results are also written to a specific register file location with a particular clock cycle delay, and this location within the write-back circuitry 706 may likewise be identified via a similar indexing system that was defined above with respect to the broadcast destination indexes. That is, and referring back to FIG. 6C, the specific datapath route within the write-back circuitry may be defined per operation result (i.e. 5@RF0, 1@RF1, 2@RF1) via the use of an encoded operation result destination index that is selected from an enumerated list, which may be the same enumerated list used for the broadcast destination indexes. The broadcast control circuitry as shown in FIG. 4B may receive and/or decode the encoded operation result destination indexes from the instruction directly or as part of a decoding process (not shown).

In any event, the broadcast destination index outputs need to be combined with the operation result destination indexes to produce the control signals, which is performed by the MPU 900 as shown in FIG. 9. It is noted that the pipeline control signals may differ per programmable processing array architecture, and the control signals as discussed herein are provided for ease of explanation with respect to the programmable processor array 700 as shown and discussed above with respect to FIG. 7. As further discussed below, the multi-path unit 900 is configured to generate control signals from the received broadcast destination indexes and the operation result destination indexes. These control signals comprise register file write indexes for the multiplexers that form part of the result port selection circuitry 702, the bus selection per write port signals (wpsel), and the result port selection per bus signals (bsel).

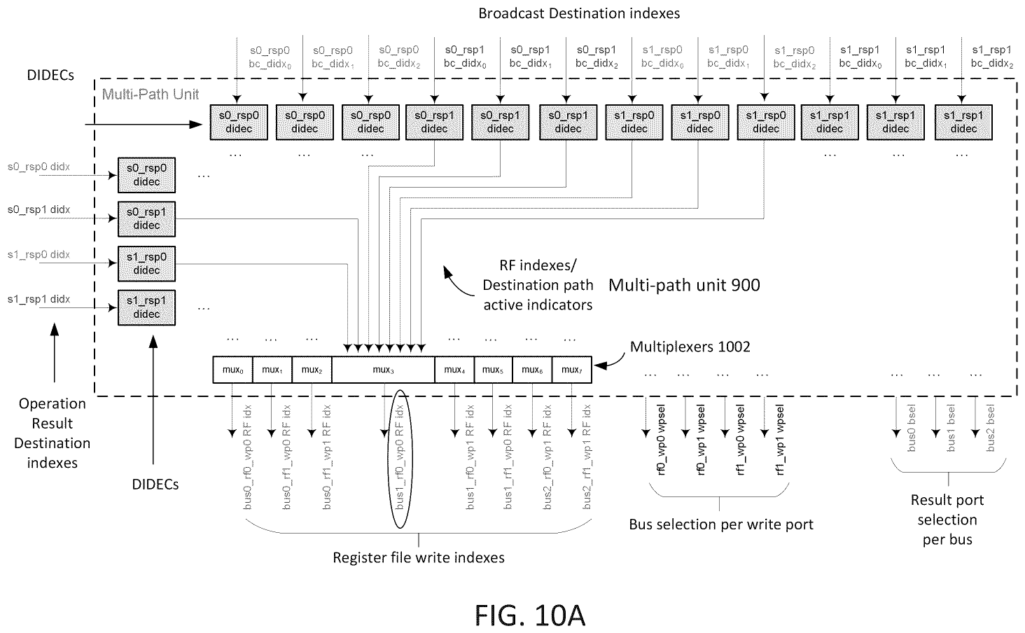

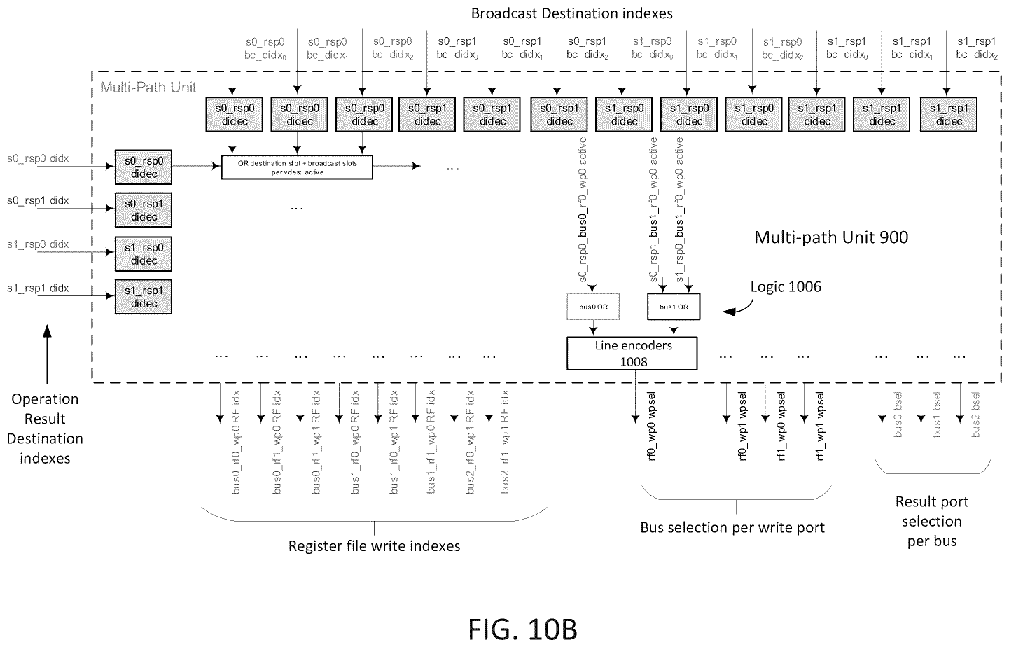

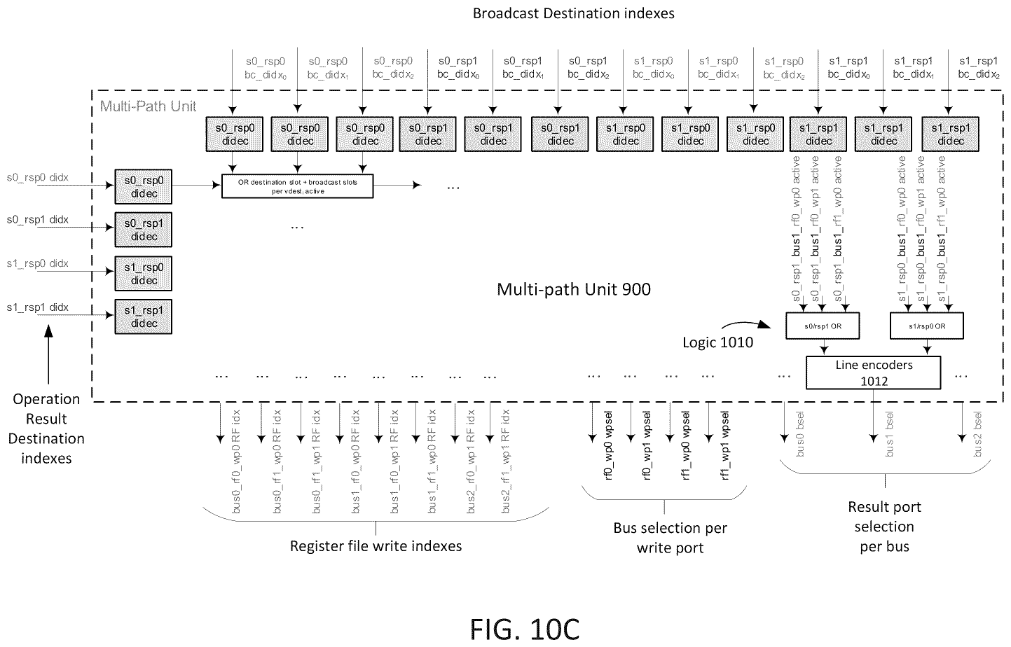

FIGS. 10A-10C illustrate further detail regarding the architecture of the MPU 900. FIG. 10A illustrates the multiplexing of all register file write indexes for result ports and associated broadcast slots connected to a specific bus-to-register file write port path. That is, to support unconstrained broadcasting of a value over a certain bus, each connected register file write port needs to be able to receive an independent write index. The MPU 900 thus receives the broadcast destination indexes as shown in FIG. 10, each being coupled to a respective destination index decoder (DIDEC). Likewise, each operation result destination index is coupled to a respective DIDEC.

For instance, and as shown in FIG. 10A, each broadcast destination index output by the broadcast delay unit 800 as noted above is coupled to a respective DIDEC for each broadcast slot for slot 0 and result port 0. The remaining DIDECs likewise receive a corresponding broadcast destination index per broadcast slot and result port combination as shown. The DIDECs shown in the vertical direction also receive an operation result destination index on a per slot and result port basis, and thus a total of four DIDECs are shown in the vertical direction in FIG. 10A, each being identified with one of the slot and result ports of the programmable processing array 700.

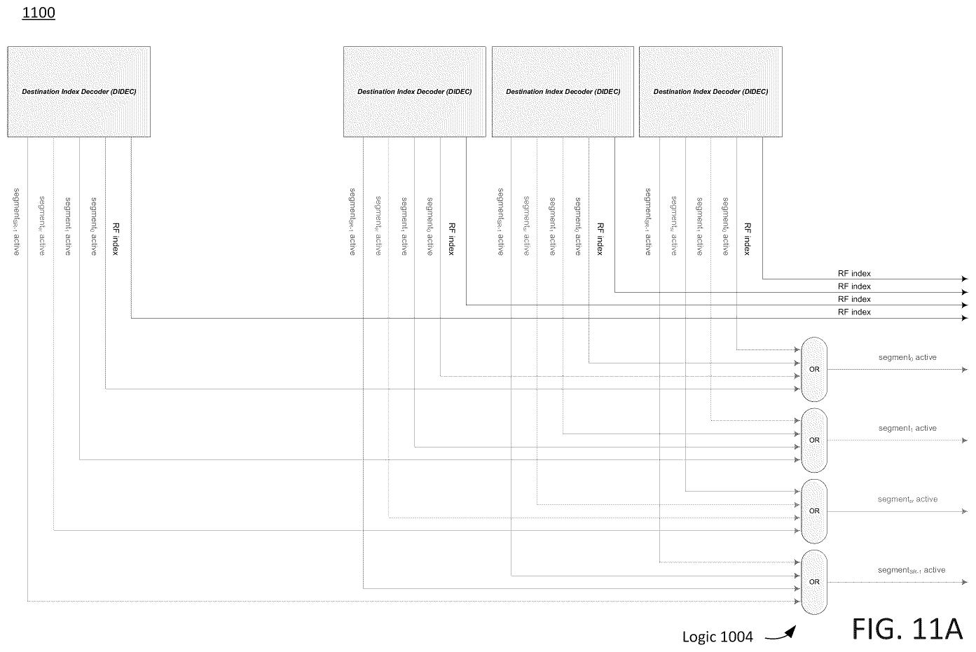

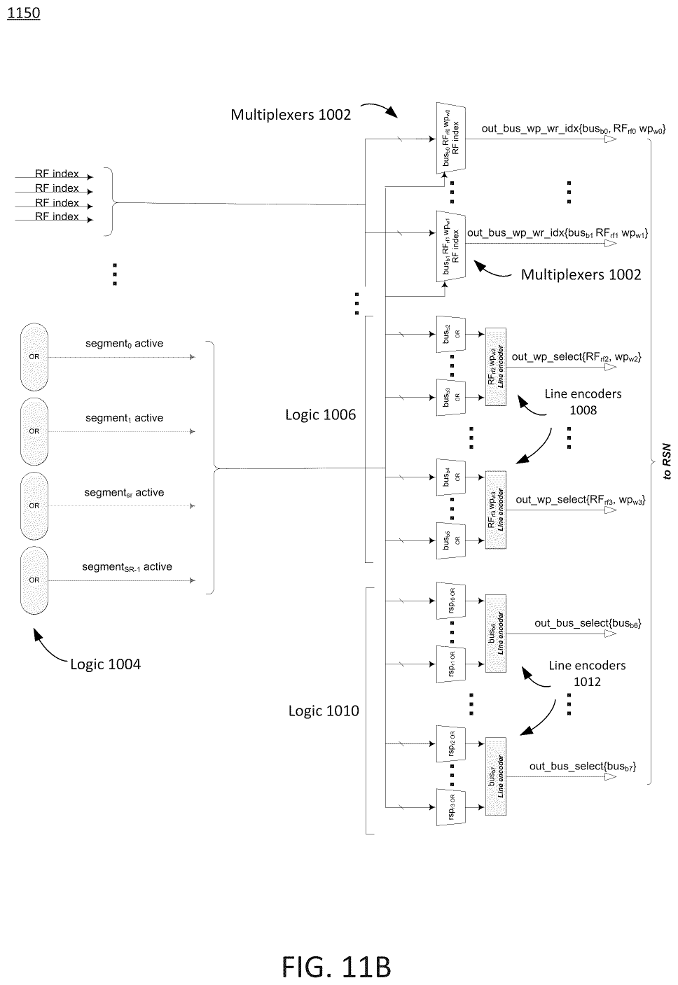

Each of the DIDECs as shown in FIG. 10A may be implemented as any suitable combination of hardware and/or software components, and is configured to translate a respective destination index to a set of datapath signals. These datapath signals comprise a register file write index and a set of destination path active indicators, as shown in further detail in FIG. 11A. The register file (RF) write indexes represent respective register file location for a specific register file to which a particular operation result or broadcasted copy of the operation result, as the case may be, is to be written. The destination path active indicators are shown in further detail in FIG. 11A, and comprise a number of active segment signals. Thus, the destination path active indicators represent each possible path from a respective issue slot result port to the various register file write ports, i.e. the various segments of a particular datapath within the write-back circuitry 706.

Moreover, each DIDEC may optionally output an additional destination path active indicator that represents a scenario in which an operation result is discarded. These may be referred to herein as “discard” or “dummy” destinations, and may be used when one of the outputs of an operation result is not needed, and should thus not be stored in a register file where it would otherwise pointlessly occupy a register. For the implementation as shown in FIG. 10A-10C, it is noted that the destination path active output of the DIDEC that represents the discard destination is not connected. When the discard destination path active output is asserted (i.e. active), this implies that the other DIDEC destination path active signals are not asserted, and therefore by construction the associated operation result will not be routed via the RSN (i.e. no associated RF index mux selection, wpsel, or bsel). It is further noted that the discarding of an operation result may alternatively be implemented via the use of a dedicated bit in the operation format (i.e. as part of the instruction), which would indicate that the operation result should be written to one or more RFs. Having a discard destination enables the ability to potentially reserve the use of this bit in the instruction, as the destination index bit width often provides some headroom (i.e. the number of destinations that are covered by a given destination index is smaller than 2 to the power of its bit width).

In other words, the DIDECs are configured using knowledge of the hardware architecture of the programmable processing array 700. Using this knowledge, each DIDEC is configured to decode a respectively received destination index into the register file write index and constituent portions of the datapath to be used to implement writing a particular operation result or broadcasted operation result to that register file index along a specific datapath. Thus, each active segment signal as shown in FIG. 11A may represent a binary representation of a portion of the datapath that is to be used (or not used) to write data to a specific register index file location. The segments may thus represent any level of granularity with respect to the datapath that is implemented. For instance, for results output at slot 1, result port 0, one segment may comprise the use of bus1, another segment may represent the portion of the datapath that comprises the output of bus1 to the input of rf0_wp0, another segment may comprise the portion of the datapath that comprises the output of bus1 to the input of rf0_wp1, whereas another segment may comprise the portion of the datapath that comprises the output of bust to the input of rf1_wp01. The segments may alternatively represent any suitable combination of a bus and other portion of the datapath, such as a bus and a write port combination. In this scenario, for results output at slot 1, result port 0, a segment may represent the use of bus 1 and any one of write ports wp0 for RF0, wp1 for RF0, or wp0 for RF1. Thus, each DIDEC may output any suitable number of active segment signals depending upon the possible combinations of datapaths that may be used to write the results output at that issue slot and result port to any reachable register file location. Thus, although four active segment signals are shown in FIG. 11A, this is a non-limiting and illustrative scenario that is shown for ease of explanation.

To provide an illustrative and non-limiting scenario, consider the DIDEC for issue slot “slot0” and its first result port “rsp0.” As shown in FIG. 7, the result port rsp0 for slot 0 connects to the multiplexer labeled “bus0,” and may reach the write port “wp0” of register file “rf0” and both write ports “wp0” and “wp1” of register file “rf1.” The associated destination path active indicators for this DIDEC thus include the following:
slot0_rsp0_bus0_rf0_wp0_active
slot0_rsp0_bus0_rf1_wp0_active
slot0_rsp0_bus0_rf1_wp1_active

It is noted that the DIDECs involved in decoding the broadcast destination indices for a certain issue slot result port are identical to the operation result destination indices for that same issue slot result port. This is indicated via the same notation used for the same issue slots and result ports for both the broadcast destination DIDECs and the operation result destination DIDECS as shown in FIG. 10A.

The MCU 900 also comprises any suitable number of multiplexers 1002, as shown in FIG. 10A, which function to output a single register file write index from the set of received register file write indexes output by the DIDECs. To do so, it is also noted that the MCU 900 also comprises logic 1004, as shown in FIGS. 11A and 11B. The logic 1004 is not shown in FIGS. 10A-10C for purposes of brevity, but may comprise any suitable number of DIDEC OR gates configured to receive each one of the active segment signals output by each of the DIDECs. That is, and as shown in FIG. 11A, each DIDEC OR gate receives the same active segment signal output by each one of the DIDECs for the same issue slot and result port. Due to the architecture of the programmable processing array 700, at most one of these active segments will be asserted at any given time, because a single datapath is used to write a single result to the register files at one time to prevent data contention. In other words, each of the active segment signals fed into each OR gate as shown in FIG. 11A represents “one-hot” logic. Thus, the logic 1004 outputs, for each OR gate, a segment active signal that corresponds to one of the DIDECs that is specific to an issue slot and result port.

Moreover, the register file indexes output by each DIDEC are coupled to a respective multiplexer 1002 as shown in further detail in FIGS. 11A and 11B. Each multiplexer 1002 may receive register file indexes from DIDECs identified with a specific set of issue slots and result ports based upon the architecture of the programmable processing array 700. Thus, each multiplexer 1002 may receive a subset of the RF indexes output by the DIDECs, as shown in FIG. 10A. The MCU 900 may thus implement any suitable number of multiplexers, logic, and/or line decoders to manage the translation of the destination indexes to control signals as discussed in further detail herein.

For instance, FIG. 10A illustrates a set of multiplexers 1002, which are shown in further detail in FIG. 11B. The multiplexers 1002 receive the RF indexes output by a predetermined subset of the DIDECs, as noted above, with the four RF indexes as shown in FIG. 11B being coupled to each of the multiplexers 1002 for ease of explanation. Each of the multiplexers 1002 outputs a single RF index that is selected via the active segment signals output by the logic 1004, as shown in FIG. 11B. In other words, in the case of the register file write index multiplexers 1002, the destination path active indicators may be directly used to control a respective multiplexer by forming a one-hot control signal. To provide an illustrative and non-limiting scenario, the register file write index multiplexer for “bus1_rf0_wp0” (circled) receives indices from either slot0_rsp1 or slot1_rsp0. The multiplexer will be one-hot controlled by the concatenation of destination path active indicators as follows:
slot0_rsp1_bus0_rf0_wp0_active
slot1_rsp0_bus0_rf0_wp0_active

Again, the DIDEC outputs are first routed through the DIDEC OR gates as shown in FIG. 11A, which form part of the logic 1004, and then presented as destination path active signals to the logic that is described further below. Turning now to FIG. 10B, the generation of the “wpsel” control signal outputs is provided in further detail. The wpsel control signals are labeled as the bus selection per write port signals, and control the selection of the multiplexers in the write port selection circuitry 704 as shown in FIG. 7. These control signals represent a binary encoded bus selection for each register file write port as shown in FIG. 10B. The wpsel control signals are generated as shown in FIG. 10B using a one-hot signal that is created by OR-ing the contributing destination path active indicators per bus (i.e. as specified per mux) via the logic 1006, as shown in further detail in FIG. 11B.

Thus, FIG. 10B illustrates the generation of the rf0_wp0 wpsel output, as there are two buses connected to rf0_wp0 as shown in FIG. 7. However, there is a single destination path active signal corresponding to both bus0 and rf0_wp0, and therefore the “bus0 OR” logic is illustrated in FIG. 10B as being grayed-out. There are also two destination path active signals associated with bus1 and rf0_wp0. These two signals are OR-ed together, and the resulting one-hot vector is 2 bits long and represents the usage of both buses, i.e. “buss) used” and “bus1 used.” This one-hot vector is translated to binary encoding by means of the line encoder 1008. That is, the MCU 900 further comprises the line decoders 1008 to translate the OR-ed wpsel control signals to a single binary representation, with this signal being coupled to a respective multiplexer that forms part of the write port selection circuitry 704. FIG. 10B illustrates a non-limiting and illustrative scenario to output a binary wpsel control signal that selects the write port “wp0” of register file “rf0.”

As noted above, the DIDEC outputs are first routed through the DIDEC OR gates as shown in FIG. 11A, which form part of the logic 1004, and then presented as destination path active signals to the logic that is described further below. Thus, turning now to FIG. 10C, similarly, in case of the “bsel” outputs, a one-hot signal is then created by OR-ing the contributing destination path active indicators per issue slot result port via the logic 1010. The bsel outputs control signals are labeled as the result port selection per bus control signals in FIGS. 10A-10C, and represent a binary encoded issue slot result port selection for each multiplexer in the result port selection circuitry 702 as shown in FIG. 7. As shown in FIG. 10C, the identical destination path active indicators output from the operation result destination DIDEC and broadcast destination DIDECs are first be OR-ed together and fed to another line encoder 1012. Thus, in FIG. 10C, a non-limiting and illustrative scenario is shown in in which the indicator selection corresponds to the multiplexer “bus1” as shown in FIG. 7, which again forms part of the result port selection circuitry 702.

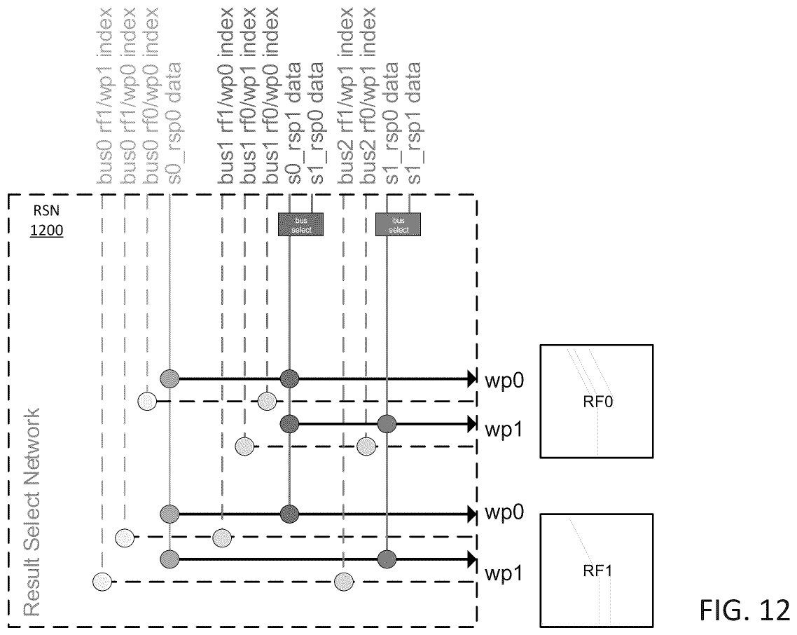

It is noted that the bus structure that handles the write back of issue slot result port values needs to be able to receive a register file write index per connected register file write port. Thus, FIG. 12 illustrates an abstraction of a result select network 1200 structure, which has been modified to carry a write index per register file write port. FIG. 12 is shown as an alternate view of the result port selection circuitry 702 and the write port selection circuitry 704, and provides additional detail with respect to the RF index paths and corresponding logic. The data paths are drawn with solid lines and dark colored muxes, whereas the RF index paths use striped lines with light colored muxes. In this way, the RSN 1200 receives, for each bus:
A RF write index per connected RF write port;
A ‘wpsel’ for each RF write port;
A ‘bsel’ for each bus; and
Result port data (i.e. operation results) for each result port.

The RF write index for each RF write port is selected by means of the “wpsel” signal for that RF write port, and the result port data for each bus is selected by means of the “bsel” signal for that bus. It is also noted that “bus0” does not have a bus select, as it only connects to slot0 rsp0.

The RSN 1200 thus receives each of the output control signals output by the MCU 900 as shown in FIG. 11B, which are then coupled to the appropriate inputs of the result port selection circuitry 702 and the write port selection circuitry 704 to ensure the translation of the control signals to select the appropriate data paths for each result (i.e. operation result or broadcasted operation result) that is to be written to a specific designation register location.

IX. An Electronic Device

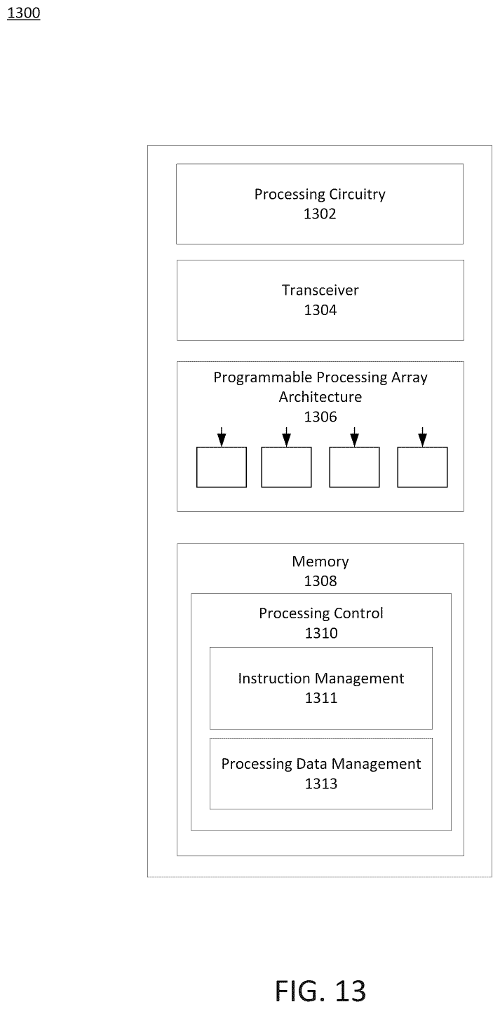

FIG. 13 illustrates an example device, in accordance with the present disclosure. The device 1300 may be identified with one or more devices implementing a programmable processing array architecture to perform processing operations, such as the programmable processing array 700 as shown and discussed herein with reference to FIG. 7. The device 1300 may be identified with a wireless device, a user equipment (UE) or other suitable device configured to perform wireless communications such as a mobile phone, a laptop computer, a cellular base station, a tablet, etc., which may include one or more components configured to transmit and receive radio signals. The programmable processing array 700 as discussed herein may facilitate, by way of its operation as discussed herein, the execution of any suitable number and/or type of processing operations that may be used as part of the transmission and/or reception of wireless signals via the electronic device 1300. Thus, the processing operations may comprise any suitable type of digital signal processing in accordance with wirelessly transmitted and/or received data, which may include filter processing, digital front-end (DFE) processing, etc. Alternatively, the device 1300 may be identified with a graphics processing unit (GPU), which may perform graphic processing on streams of graphical data.

As further discussed below, the device 1300 may perform the functions as discussed herein with respect to the programmable processing array 700 as shown and discussed herein with reference to FIG. 7. The device 1300 may perform processing operations by receiving processor instructions having any suitable number of fields. These processing operations may be performed using locally-implemented or embedded buffers to store sets of data samples and the output of performing data processing on the stored sets of data samples. To do so, the device 1300 may include processing circuitry 1302, a transceiver 1304, a programmable processing array architecture 1306, and a memory 1308. The components shown in FIG. 13 are provided for ease of explanation, and the device 1300 may implement additional, less, or alternative components as those shown in FIG. 13. In one scenario, the transceiver 1304 may be omitted when the device 1300 is implemented as a GPU.

The processing circuitry 1302 may be configured as any suitable number and/or type of computer processors, which may function to control the device 1300 and/or other components of the device 1300. The processing circuitry 1302 may be identified with one or more processors (or suitable portions thereof) implemented by the device 1300. The processing circuitry 1302 may be identified with one or more processors such as a host processor, a digital signal processor, one or more microprocessors, graphics processors, baseband processors, microcontrollers, an application-specific integrated circuit (ASIC), part (or the entirety of) a field-programmable gate array (FPGA), etc.

In any event, the processing circuitry 1302 may be configured to carry out instructions to perform arithmetical, logical, and/or input/output (I/O) operations, and/or to control the operation of one or more components of device 1300 to perform various functions as described herein. The processing circuitry 1302 may include one or more microprocessor cores, memory registers, buffers, clocks, etc., and may generate electronic control signals associated with the components of the device 1300 to control and/or modify the operation of these components. The processing circuitry 1302 may communicate with and/or control functions associated with the transceiver 1304, the programmable processing array architecture 1306, and/or the memory 1308.

The transceiver 1304 (when present) may be implemented as any suitable number and/or type of components configured to transmit and/or receive data (such as data packets) and/or wireless signals in accordance with any suitable number and/or type of communication protocols. The transceiver 1304 may include any suitable type of components to facilitate this functionality, including components associated with known transceiver, transmitter, and/or receiver operation, configurations, and implementations. Although depicted in FIG. 13 as a transceiver, the transceiver 1304 may include any suitable number of transmitters, receivers, or combinations of these that may be integrated into a single transceiver or as multiple transceivers or transceiver modules. The transceiver 1304 may include components typically identified with an RF front end and include antennas, ports, power amplifiers (PAs), RF filters, mixers, local oscillators (LOs), low noise amplifiers (LNAs), upconverters, downconverters, channel tuners, etc.

Thus, the transceiver 1304 may be configured as any suitable number and/or type of components configured to facilitate receiving and/or transmitting data and/or signals in accordance with one or more communication protocols. The transceiver 1304 may be implemented as any suitable number and/or type of components to support wireless communications such as analog-to-digital converters (ADCs), digital to analog converters, intermediate frequency (IF) amplifiers and/or filters, modulators, demodulators, baseband processors, etc. The data received via the transceiver 1304 (e.g. wireless signal data streams), data provided to the transceiver 1304 for transmission (e.g. data streams for transmission), and/or data used in conjunction with the transmission and/or reception of data via the transceiver 1304 (e.g. digital filter coefficients, digital pre-distortion (DPD) terms, etc.) may be processed as data streams via the programmable processing array architecture 1306 as part of its processing operations as discussed herein. Thus, the programmable processing array architecture 1306 may be identified with the programmable processing array 700, as shown and described herein with reference to FIG. 7. In this way, the transceiver 1304 may be configured to transmit and/or receive data signals based upon digital signal processing operations performed via the programmable processing array 700, which again may be identified with the programmable processing array architecture 1306.

The memory 1308 is configured to store data and/or instructions such that, when the instructions are executed by the processing circuitry 1302, cause the device 1300 to perform various functions as described herein with respect to the programmable processing array architecture 1306, such as controlling, monitoring, and/or regulating the flow of data through the programmable processing array architecture 1306. The memory 1308 may be implemented as any suitable volatile and/or non-volatile memory, including read-only memory (ROM), random access memory (RAM), flash memory, a magnetic storage media, an optical disc, erasable programmable read only memory (EPROM), programmable read only memory (PROM), etc. The memory 1308 may be non-removable, removable, or a combination of both. The memory 1308 may be implemented as a non-transitory computer readable medium storing one or more executable instructions such as, for example, logic, algorithms, code, etc.

As further discussed below, the instructions, logic, code, etc., stored in the memory 1308 are represented by the various modules as shown, which may enable the functionality disclosed herein to be functionally realized. Alternatively, the modules as shown in FIG. 13 that are associated with the memory 1308 may include instructions and/or code to facilitate control and/or monitor the operation of hardware components implemented via the device 1300. In other words, the modules shown in FIG. 13 are provided for ease of explanation regarding the functional association between hardware and software components. Thus, the processing circuitry 1302 may execute the instructions stored in these respective modules in conjunction with one or more hardware components to perform the various functions as discussed herein.

The processing control engine 1310 may represent the functionality described herein as discussed with reference to controlling and/or monitoring the programmable processing array architecture 1306. The processing control engine 1310 may represent a program memory (and stored instruction sets), a decoder, and/or the memory as discussed herein with reference to FIG. 7, such as the various register files. Additionally or alternatively, one or more of the program memory, the decoder, and/or the register files may form part of the processing circuitry 1302, the memory 1308, the programmable processing array architecture 1306, or separate components not shown in FIG. 13.

The executable instructions stored in the instruction management module 1311 may facilitate, in conjunction with execution via the processing circuitry 1302, the device 1300 receiving and decoding processor instructions (which may be sent via the processing circuitry 1302 or other suitable component of the device 1300 or a component external to the device 1300), and providing data samples to the programmable processing array architecture 1306. This may include a determination of each specific processor instruction to perform specific types of processing operations, broadcasting operations, and/or any of the functionality as discussed herein with respect to the programmable processing array 700 such as reading data samples from and writing data samples to the register files, the generation of processor instructions and/or control signals, the calculations identified with various processing operations, etc.

The executable instructions stored in the processing data management module 1313 may facilitate, in conjunction with execution via the processing circuitry 1302, the determination of when the calculated results of processing operations are completed and when to store these operation results and the accompanying broadcasted operations results. This may include writing the results in one or more registers files to be utilized by the appropriate components of the device 1300 or other suitable device.

X. A Process Flow

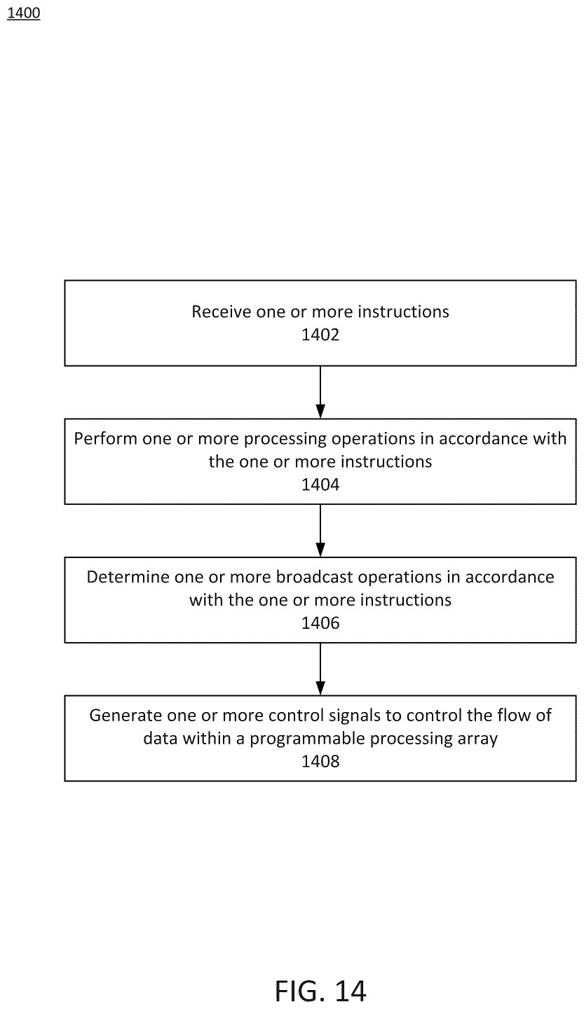

FIG. 14 illustrates a process flow. With reference to FIG. 14, the process flow 1400 may be executed by and/or otherwise associated with processing circuitry and/or storage devices. These processors and/or storage devices may be associated with one or more components of the programmable processing array 700 as discussed herein and/or one or more components of the device 1300 as discussed herein. To provide an illustrative and non-limiting scenario, the process flow 1400 may be performed via the broadcast control circuitry 708 as discussed in further detail herein. Additionally or alternatively, the processors and/or storage devices may be identified with the one or more functional units of the programmable processing array 700 and/or the processing circuitry 1302, as discussed above. The flow 1400 may include alternate or additional steps that are not shown in FIG. 14 for purposes of brevity, and may be performed in a different order than the steps shown in FIG. 14.

Flow 1400 may begin with one or more processors receiving (block 1402) one or more instructions. These instructions may be received, in one non-limiting and illustrative scenario, as a VLIW instruction having the format as discussed herein with respect to FIGS. 6A-6C.

Flow 1400 may include one or more processors performing (block 1404) one or more processing operations in accordance with the one or more received instructions. This may include, in one non-limiting and illustrative scenario, processing operations executed by the functional units of the programmable processing array 700 based upon the received instruction.

Flow 1400 may include one or more processors determining (block 1406) one or more broadcasting operations in accordance with the one or more received instructions. This may include, in one non-limiting and illustrative scenario, the identification of broadcasting operations that are included as part of the payload of the received instruction(s). As noted above, this determination may be performed via the broadcast control circuitry 708, which may comprise a dedicated functional unit.

Flow 1400 may include one or more processors generating (block 1408) one or more control signals to control the flow of data within the programmable processing array. This may include, in one non-limiting and illustrative scenario, the generation of the control signals via the broadcast control circuitry 08 as discussed above, which function to control the flow of data within the write-back circuitry 706. As a result of this flow control, the operation results are copied (i.e. broadcasted) to one or more registers of the register files in accordance with one or more broadcasting operations as defined via the respectively received instruction.

XI. General Operation of a Programmable Processor Array

A programmable processing array is provided. The programmable processing array comprises a plurality of execution units coupled to a plurality of register files via write-back circuitry, each of the plurality of execution units being configured to perform, in accordance with a respectively received instruction, one or more processing operations on data accessed from the plurality of register files to provide operation results; and broadcast control circuitry configured to generate control signals to control a flow of data within the write-back circuitry to thereby copy, to one or more registers of the plurality of register files in accordance with one or more broadcasting operations defined via the respectively received instruction, one or more operation results provided by one or more of the plurality of execution units. In addition or in alternative to and in any combination with the optional features previously explained in this paragraph, the instruction complies with a very long instruction word (VLIW) instruction format, and the one or more broadcasting operations are defined as part of a payload of the instruction. In addition or in alternative to and in any combination with the optional features previously explained in this paragraph, the programmable processing array comprises part of a data stationary encoding (DSE) processor architecture. In addition or in alternative to and in any combination with the optional features previously explained in this paragraph, the instruction identifies, for each operation to be performed, (i) a respective register location from among the plurality of registers to store a respective operation result, and (ii) one or more respective register locations from among the plurality of registers to copy the respective operation result as part of the one or more broadcasting operations. In addition or in alternative to and in any combination with the optional features previously explained in this paragraph, the instruction comprises, for each of the one or more broadcasting operations, an encoded operation result identifier that uniquely identifies each respective operation result. In addition or in alternative to and in any combination with the optional features previously explained in this paragraph, the instruction comprises, for each of the one or more broadcasting operations, an encoded result destination identifier that uniquely identifies a datapath within the write-back circuitry to be used to copy each respective operation result provided via the one or more execution units in accordance with the respective one or more broadcasting operations. In addition or in alternative to and in any combination with the optional features previously explained in this paragraph, the instruction comprises, for each of the one or more broadcasting operations, a result port identifier from among a set of enumerated result port identifiers, and each one of the set of enumerated result port identifiers indicates (i) an issue slot result port of the programmable processing array, and (ii) a corresponding clock cycle delay associated with each respective operation result being provided at a respective issue slot result port. In addition or in alternative to and in any combination with the optional features previously explained in this paragraph, the encoded result destination identifier comprises a destination index that identifies a respective register location from among the plurality of registers where a respective operation result is to be copied in accordance with the respective one or more broadcasting operations. In addition or in alternative to and in any combination with the optional features previously explained in this paragraph, the broadcast control circuitry comprises delay circuitry configured to output, for each one of the one or more broadcasting operations, a respective destination index at a corresponding clock cycle delay associated with the respective operation result to be copied. In addition or in alternative to and in any combination with the optional features previously explained in this paragraph, the broadcast control circuitry comprises comparison circuitry configured to output a respective destination index that matches a predetermined issue slot result port of the programmable processing array and a predetermined clock cycle delay. In addition or in alternative to and in any combination with the optional features previously explained in this paragraph, the broadcast control circuitry further comprises multi-path control circuitry configured to: receive, for each of the one or more operation results provided by one or more of the plurality of execution units, a further destination index that identifies a respective register location from among the plurality of registers where each respective operation result is to be written; and translate the received destination indexes and further destination indexes to the control signals.

XII. General Operation of an Electronic Device

An electronic device is provided. The electronic device comprises a programmable processing array comprising a plurality of execution units coupled to a plurality of register files via write-back circuitry, each of the plurality of execution units being configured to perform, in accordance with a respectively received instruction, one or more processing operations on data accessed from the plurality of register files to provide operation results, wherein the programmable processing array is configured to generate control signals to control a flow of data within the write-back circuitry to thereby copy, to one or more registers of the plurality of register files in accordance with one or more broadcasting operations defined via the respectively received instruction, one or more operation results provided by one or more of the plurality of execution units; and a transceiver configured to transmit data signals based upon digital signal processing operations performed via the programmable processing array. In addition or in alternative to and in any combination with the optional features previously explained in this paragraph, the instruction complies with a very long instruction word (VLIW) instruction format, the one or more broadcasting operations are defined as part of a payload of the instruction, and the programmable processing array comprises part of a data stationary encoding (DSE) processor architecture. In addition or in alternative to and in any combination with the optional features previously explained in this paragraph, the instruction identifies, for each operation to be performed, (i) a respective register location from among the plurality of registers to store a respective operation result, and (ii) one or more respective register locations from among the plurality of registers to copy the respective operation result as part of the one or more broadcasting operations. In addition or in alternative to and in any combination with the optional features previously explained in this paragraph, the instruction comprises, for each of the one or more broadcasting operations, an encoded operation result identifier that uniquely identifies each respective operation result. In addition or in alternative to and in any combination with the optional features previously explained in this paragraph, the instruction comprises, for each of the one or more broadcasting operations, an encoded result destination identifier that uniquely identifies a datapath within the write-back circuitry to be used to copy each respective operation result provided via the one or more execution units in accordance with the respective one or more broadcasting operations. In addition or in alternative to and in any combination with the optional features previously explained in this paragraph, the instruction comprises, for each of the one or more broadcasting operations, a result port identifier from among a set of enumerated result port identifiers, and each one of the set of enumerated result port identifiers indicates (i) an issue slot result port of the programmable processing array, and (ii) a corresponding clock cycle delay associated with each respective operation result being provided at a respective issue slot result port. In addition or in alternative to and in any combination with the optional features previously explained in this paragraph, the encoded result destination identifier comprises a destination index that identifies a respective register location from among the plurality of registers where a respective operation result is to be copied in accordance with the respective one or more broadcasting operations. In addition or in alternative to and in any combination with the optional features previously explained in this paragraph, the broadcast control circuitry comprises delay circuitry configured to output, for each one of the one or more broadcasting operations, a respective destination index at a corresponding clock cycle delay associated with the respective operation result to be copied. In addition or in alternative to and in any combination with the optional features previously explained in this paragraph, the broadcast control circuitry comprises comparison circuitry configured to output a respective destination index that matches a predetermined issue slot result port of the programmable processing array and a predetermined clock cycle delay.

### EXAMPLES

The following examples pertain to further aspects.

An example (e.g. example 1) is directed to a programmable processing array, comprising: a plurality of execution units coupled to a plurality of register files via write-back circuitry, each of the plurality of execution units being configured to perform, in accordance with a respectively received instruction, one or more processing operations on data accessed from the plurality of register files to provide operation results; and broadcast control circuitry configured to generate control signals to control a flow of data within the write-back circuitry to thereby copy, to one or more registers of the plurality of register files in accordance with one or more broadcasting operations defined via the respectively received instruction, one or more operation results provided by one or more of the plurality of execution units.

Another example (e.g. example 2) relates to a previously-described example (e.g. example 1), wherein the instruction complies with a very long instruction word (VLIW) instruction format, and the one or more broadcasting operations are defined as part of a payload of the instruction.

Another example (e.g. example 3) relates to a previously-described example (e.g. one or more of examples 1-2), wherein the programmable processing array comprises part of a data stationary encoding (DSE) processor architecture.

Another example (e.g. example 4) relates to a previously-described example (e.g. one or more of examples 1-3), wherein the instruction identifies, for each operation to be performed, (i) a respective register location from among the plurality of registers to store a respective operation result, and (ii) one or more respective register locations from among the plurality of registers to copy the respective operation result as part of the one or more broadcasting operations.

Another example (e.g. example 5) relates to a previously-described example (e.g. one or more of examples 1-4), wherein the instruction comprises, for each of the one or more broadcasting operations, an encoded operation result identifier that uniquely identifies each respective operation result.

Another example (e.g. example 6) relates to a previously-described example (e.g. one or more of examples 1-5), wherein the instruction comprises, for each of the one or more broadcasting operations, an encoded result destination identifier that uniquely identifies a datapath within the write-back circuitry to be used to copy each respective operation result provided via the one or more execution units in accordance with the respective one or more broadcasting operations.

Another example (e.g. example 7) relates to a previously-described example (e.g. one or more of examples 1-6), wherein the instruction comprises, for each of the one or more broadcasting operations, a result port identifier from among a set of enumerated result port identifiers, wherein each one of the set of enumerated result port identifiers indicates (i) an issue slot result port of the programmable processing array, and (ii) a corresponding clock cycle delay associated with each respective operation result being provided at a respective issue slot result port.

Another example (e.g. example 8) relates to a previously-described example (e.g. one or more of examples 1-7), wherein the encoded result destination identifier comprises a destination index that identifies a respective register location from among the plurality of registers where a respective operation result is to be copied in accordance with the respective one or more broadcasting operations.

Another example (e.g. example 9) relates to a previously-described example (e.g. one or more of examples 1-8), wherein the broadcast control circuitry comprises delay circuitry configured to output, for each one of the one or more broadcasting operations, a respective destination index at a corresponding clock cycle delay associated with the respective operation result to be copied.

Another example (e.g. example 10) relates to a previously-described example (e.g. one or more of examples 1-9), wherein the broadcast control circuitry comprises comparison circuitry configured to output a respective destination index that matches a predetermined issue slot result port of the programmable processing array and a predetermined clock cycle delay.

Another example (e.g. example 11) relates to a previously-described example (e.g. one or more of examples 1-10), wherein the broadcast control circuitry further comprises multi-path control circuitry configured to: receive, for each of the one or more operation results provided by one or more of the plurality of execution units, a further destination index that identifies a respective register location from among the plurality of registers where each respective operation result is to be written; and translate the received destination indexes and further destination indexes to the control signals.

An example (e.g. example 12) is directed to an electronic device, comprising: a programmable processing array comprising a plurality of execution units coupled to a plurality of register files via write-back circuitry, each of the plurality of execution units being configured to perform, in accordance with a respectively received instruction, one or more processing operations on data accessed from the plurality of register files to provide operation results, wherein the programmable processing array is configured to generate control signals to control a flow of data within the write-back circuitry to thereby copy, to one or more registers of the plurality of register files in accordance with one or more broadcasting operations defined via the respectively received instruction, one or more operation results provided by one or more of the plurality of execution units; and a transceiver configured to transmit data signals based upon digital signal processing operations performed via the programmable processing array.

Another example (e.g. example 13) relates to a previously-described example (e.g. example 12), wherein: the instruction complies with a very long instruction word (VLIW) instruction format, the one or more broadcasting operations are defined as part of a payload of the instruction, and the programmable processing array comprises part of a data stationary encoding (DSE) processor architecture.

Another example (e.g. example 14) relates to a previously-described example (e.g. one or more of examples 12-13), wherein the instruction identifies, for each operation to be performed, (i) a respective register location from among the plurality of registers to store a respective operation result, and (ii) one or more respective register locations from among the plurality of registers to copy the respective operation result as part of the one or more broadcasting operations.

Another example (e.g. example 15) relates to a previously-described example (e.g. one or more of examples 12-14), wherein the instruction comprises, for each of the one or more broadcasting operations, an encoded operation result identifier that uniquely identifies each respective operation result.

Another example (e.g. example 16) relates to a previously-described example (e.g. one or more of examples 12-15), wherein the instruction comprises, for each of the one or more broadcasting operations, an encoded result destination identifier that uniquely identifies a datapath within the write-back circuitry to be used to copy each respective operation result provided via the one or more execution units in accordance with the respective one or more broadcasting operations.

Another example (e.g. example 17) relates to a previously-described example (e.g. one or more of examples 12-16), wherein the instruction comprises, for each of the one or more broadcasting operations, a result port identifier from among a set of enumerated result port identifiers, wherein each one of the set of enumerated result port identifiers indicates (i) an issue slot result port of the programmable processing array, and (ii) a corresponding clock cycle delay associated with each respective operation result being provided at a respective issue slot result port.

Another example (e.g. example 18) relates to a previously-described example (e.g. one or more of examples 12-17), wherein the encoded result destination identifier comprises a destination index that identifies a respective register location from among the plurality of registers where a respective operation result is to be copied in accordance with the respective one or more broadcasting operations.

Another example (e.g. example 19) relates to a previously-described example (e.g. one or more of examples 12-18), wherein the broadcast control circuitry comprises delay circuitry configured to output, for each one of the one or more broadcasting operations, a respective destination index at a corresponding clock cycle delay associated with the respective operation result to be copied.

Another example (e.g. example 20) relates to a previously-described example (e.g. one or more of examples 12-19), wherein the broadcast control circuitry comprises comparison circuitry configured to output a respective destination index that matches a predetermined issue slot result port of the programmable processing array and a predetermined clock cycle delay.

An example (e.g. example 21) is directed to a programmable processing array, comprising: a plurality of execution means coupled to a plurality of register files via a write-back means, each of the plurality of execution means performing, in accordance with a respectively received instruction, one or more processing operations on data accessed from the plurality of register files to provide operation results; and broadcast control means for generating control signals to control a flow of data within the write-back means to thereby copy, to one or more registers of the plurality of register files in accordance with one or more broadcasting operations defined via the respectively received instruction, one or more operation results provided by one or more of the plurality of execution means.

Another example (e.g. example 22) relates to a previously-described example (e.g. example 21), wherein the instruction complies with a very long instruction word (VLIW) instruction format, and the one or more broadcasting operations are defined as part of a payload of the instruction.

Another example (e.g. example 23) relates to a previously-described example (e.g. one or more of examples 21-22), wherein the programmable processing array comprises part of a data stationary encoding (DSE) processor architecture.

Another example (e.g. example 24) relates to a previously-described example (e.g. one or more of examples 21-23), wherein the instruction identifies, for each operation to be performed, (i) a respective register location from among the plurality of registers to store a respective operation result, and (ii) one or more respective register locations from among the plurality of registers to copy the respective operation result as part of the one or more broadcasting operations.

Another example (e.g. example 25) relates to a previously-described example (e.g. one or more of examples 21-24), wherein the instruction comprises, for each of the one or more broadcasting operations, an encoded operation result identifier that uniquely identifies each respective operation result.

Another example (e.g. example 26) relates to a previously-described example (e.g. one or more of examples 21-25), wherein the instruction comprises, for each of the one or more broadcasting operations, an encoded result destination identifier that uniquely identifies a datapath within the write-back means to be used to copy each respective operation result provided via the one or more execution means in accordance with the respective one or more broadcasting operations.

Another example (e.g. example 27) relates to a previously-described example (e.g. one or more of examples 21-26), wherein the instruction comprises, for each of the one or more broadcasting operations, a result port identifier from among a set of enumerated result port identifiers, wherein each one of the set of enumerated result port identifiers indicates (i) an issue slot result port of the programmable processing array, and (ii) a corresponding clock cycle delay associated with each respective operation result being provided at a respective issue slot result port.

Another example (e.g. example 28) relates to a previously-described example (e.g. one or more of examples 21-27), wherein the encoded result destination identifier comprises a destination index that identifies a respective register location from among the plurality of registers where a respective operation result is to be copied in accordance with the respective one or more broadcasting operations.

Another example (e.g. example 29) relates to a previously-described example (e.g. one or more of examples 21-28), wherein the broadcast control means comprises delay circuitry configured to output, for each one of the one or more broadcasting operations, a respective destination index at a corresponding clock cycle delay associated with the respective operation result to be copied.

Another example (e.g. example 30) relates to a previously-described example (e.g. one or more of examples 21-29), wherein the broadcast control means comprises comparison circuitry configured to output a respective destination index that matches a predetermined issue slot result port of the programmable processing array and a predetermined clock cycle delay.

Another example (e.g. example 31) relates to a previously-described example (e.g. one or more of examples 21-30), wherein the broadcast control means further comprises multi-path control circuitry configured to: receive, for each of the one or more operation results provided by one or more of the plurality of execution means, a further destination index that identifies a respective register location from among the plurality of registers where each respective operation result is to be written; and translate the received destination indexes and further destination indexes to the control signals.

An example (e.g. example 32) is directed to an electronic device, comprising: a programmable processing array comprising a plurality of execution means coupled to a plurality of register files via write-back means, each of the plurality of execution means performing, in accordance with a respectively received instruction, one or more processing operations on data accessed from the plurality of register files to provide operation results, wherein the programmable processing array is configured to generate control signals to control a flow of data within the write-back means to thereby copy, to one or more registers of the plurality of register files in accordance with one or more broadcasting operations defined via the respectively received instruction, one or more operation results provided by one or more of the plurality of execution means; and a transceiving means for transmitting data signals based upon digital signal processing operations performed via the programmable processing array.

Another example (e.g. example 33) relates to a previously-described example (e.g. example 32), wherein: the instruction complies with a very long instruction word (VLIW) instruction format, the one or more broadcasting operations are defined as part of a payload of the instruction, and the programmable processing array comprises part of a data stationary encoding (DSE) processor architecture.

Another example (e.g. example 34) relates to a previously-described example (e.g. one or more of examples 32-33), wherein the instruction identifies, for each operation to be performed, (i) a respective register location from among the plurality of registers to store a respective operation result, and (ii) one or more respective register locations from among the plurality of registers to copy the respective operation result as part of the one or more broadcasting operations.

Another example (e.g. example 35) relates to a previously-described example (e.g. one or more of examples 32-34), wherein the instruction comprises, for each of the one or more broadcasting operations, an encoded operation result identifier that uniquely identifies each respective operation result.

Another example (e.g. example 36) relates to a previously-described example (e.g. one or more of examples 32-35), wherein the instruction comprises, for each of the one or more broadcasting operations, an encoded result destination identifier that uniquely identifies a datapath within the write-back means to be used to copy each respective operation result provided via the one or more execution means in accordance with the respective one or more broadcasting operations.

Another example (e.g. example 37) relates to a previously-described example (e.g. one or more of examples 32-36), wherein the instruction comprises, for each of the one or more broadcasting operations, a result port identifier from among a set of enumerated result port identifiers, wherein each one of the set of enumerated result port identifiers indicates (i) an issue slot result port of the programmable processing array, and (ii) a corresponding clock cycle delay associated with each respective operation result being provided at a respective issue slot result port.

Another example (e.g. example 38) relates to a previously-described example (e.g. one or more of examples 32-37), wherein the encoded result destination identifier comprises a destination index that identifies a respective register location from among the plurality of registers where a respective operation result is to be copied in accordance with the respective one or more broadcasting operations.

Another example (e.g. example 39) relates to a previously-described example (e.g. one or more of examples 32-38), wherein the broadcast control means comprises delay circuitry configured to output, for each one of the one or more broadcasting operations, a respective destination index at a corresponding clock cycle delay associated with the respective operation result to be copied.

Another example (e.g. example 40) relates to a previously-described example (e.g. one or more of examples 32-39), wherein the broadcast control means comprises comparison circuitry configured to output a respective destination index that matches a predetermined issue slot result port of the programmable processing array and a predetermined clock cycle delay.

An apparatus as shown and described.

A method as shown and described.

### CONCLUSION

The aforementioned description of the specific aspects will so fully reveal the general nature of the disclosure that others can, by applying knowledge within the skill of the art, readily modify and/or adapt for various applications such specific aspects, without undue experimentation, and without departing from the general concept of the present disclosure. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one aspect,” “an aspect,” “an exemplary aspect,” etc., indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspects whether or not explicitly described.

The exemplary aspects described herein are provided for illustrative purposes, and are not limiting. Other exemplary aspects are possible, and modifications may be made to the exemplary aspects. Therefore, the specification is not meant to limit the disclosure. Rather, the scope of the disclosure is defined only in accordance with the following claims and their equivalents.

Aspects may be implemented in hardware (e.g., circuits), firmware, software, or any combination thereof. Aspects may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, the term “processing circuitry” or “processor circuitry” shall be understood to be circuit(s), processor(s), logic, or a combination thereof. For example, a circuit can include an analog circuit, a digital circuit, state machine logic, other structural electronic hardware, or a combination thereof. A processor can include a microprocessor, a digital signal processor (DSP), or other hardware processor. The processor can be “hard-coded” with instructions to perform corresponding function(s) according to aspects described herein. Alternatively, the processor can access an internal and/or external memory to retrieve instructions stored in the memory, which when executed by the processor, perform the corresponding function(s) associated with the processor, and/or one or more functions and/or operations related to the operation of a component having the processor included therein.

In one or more of the exemplary aspects described herein, processing circuitry can include memory that stores data and/or instructions. The memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

What is claimed is:

1. A programmable processing array, comprising:
a plurality of execution units coupled to a plurality of register files via write-back circuitry, each of the plurality of execution units being configured to perform, in accordance with a respectively received instruction, one or more processing operations on data accessed from the plurality of register files to provide operation results; and
broadcast control circuitry configured to generate control signals to control a flow of data within the write-back circuitry to thereby copy, to one or more registers of the plurality of register files in accordance with one or more broadcasting operations defined via the respectively received instruction, one or more operation results provided by one or more of the plurality of execution units.

2. The programmable processing array of claim 1, wherein the instruction complies with a very long instruction word (VLIW) instruction format, and
the one or more broadcasting operations are defined as part of a payload of the instruction.

3. The programmable processing array of claim 1, wherein the programmable processing array comprises part of a data stationary encoding (DSE) processor architecture.

4. The programmable processing array of claim 1, wherein the instruction identifies, for each operation to be performed, (i) a respective register location from among the plurality of registers to store a respective operation result, and (ii) one or more respective register locations from among the plurality of registers to copy the respective operation result as part of the one or more broadcasting operations.

5. The programmable processing array of claim 4, wherein the instruction comprises, for each of the one or more broadcasting operations, an encoded operation result identifier that uniquely identifies each respective operation result.

6. The programmable processing array of claim 4, wherein the instruction comprises, for each of the one or more broadcasting operations, an encoded result destination identifier that uniquely identifies a datapath within the write-back circuitry to be used to copy each respective operation result provided via the one or more execution units in accordance with the respective one or more broadcasting operations.

7. The programmable processing array of claim 1, wherein the instruction comprises, for each of the one or more broadcasting operations, a result port identifier from among a set of enumerated result port identifiers,
wherein each one of the set of enumerated result port identifiers indicates (i) an issue slot result port of the programmable processing array, and (ii) a corresponding clock cycle delay associated with each respective operation result being provided at a respective issue slot result port.

8. The programmable processing array of claim 6, wherein the encoded result destination identifier comprises a destination index that identifies a respective register location from among the plurality of registers where a respective operation result is to be copied in accordance with the respective one or more broadcasting operations.

9. The programmable processing array of claim 8, wherein the broadcast control circuitry comprises delay circuitry configured to output, for each one of the one or more broadcasting operations, a respective destination index at a corresponding clock cycle delay associated with the respective operation result to be copied.

10. The programmable processing array of claim 8, wherein the broadcast control circuitry comprises comparison circuitry configured to output a respective destination index that matches a predetermined issue slot result port of the programmable processing array and a predetermined clock cycle delay.

11. The programmable processing array of claim 10, wherein the broadcast control circuitry further comprises multi-path control circuitry configured to:
receive, for each of the one or more operation results provided by one or more of the plurality of execution units, a further destination index that identifies a respective register location from among the plurality of registers where each respective operation result is to be written; and
translate the received destination indexes and further destination indexes to the control signals.

12. An electronic device, comprising:
a programmable processing array comprising a plurality of execution units coupled to a plurality of register files via write-back circuitry, each of the plurality of execution units being configured to perform, in accordance with a respectively received instruction, one or more processing operations on data accessed from the plurality of register files to provide operation results,
wherein the programmable processing array is configured to generate control signals to control a flow of data within the write-back circuitry to thereby copy, to one or more registers of the plurality of register files in accordance with one or more broadcasting operations defined via the respectively received instruction, one or more operation results provided by one or more of the plurality of execution units; and
a transceiver configured to transmit data signals based upon digital signal processing operations performed via the programmable processing array.

13. The electronic device of claim 12, wherein:
the instruction complies with a very long instruction word (VLIW) instruction format,
the one or more broadcasting operations are defined as part of a payload of the instruction, and
the programmable processing array comprises part of a data stationary encoding (DSE) processor architecture.

14. The electronic device of claim 12, wherein the instruction identifies, for each operation to be performed, (i) a respective register location from among the plurality of registers to store a respective operation result, and (ii) one or more respective register locations from among the plurality of registers to copy the respective operation result as part of the one or more broadcasting operations.

15. The electronic device of claim 14, wherein the instruction comprises, for each of the one or more broadcasting operations, an encoded operation result identifier that uniquely identifies each respective operation result.

16. The electronic device of claim 14, wherein the instruction comprises, for each of the one or more broadcasting operations, an encoded result destination identifier that uniquely identifies a datapath within the write-back circuitry to be used to copy each respective operation result provided via the one or more execution units in accordance with the respective one or more broadcasting operations.

17. The electronic device of claim 12, wherein the instruction comprises, for each of the one or more broadcasting operations, a result port identifier from among a set of enumerated result port identifiers,
wherein each one of the set of enumerated result port identifiers indicates (i) an issue slot result port of the programmable processing array, and (ii) a corresponding clock cycle delay associated with each respective operation result being provided at a respective issue slot result port.

18. The electronic device of claim 16, wherein the encoded result destination identifier comprises a destination index that identifies a respective register location from among the plurality of registers where a respective operation result is to be copied in accordance with the respective one or more broadcasting operations.

19. The electronic device of claim 18, wherein the broadcast control circuitry comprises delay circuitry configured to output, for each one of the one or more broadcasting operations, a respective destination index at a corresponding clock cycle delay associated with the respective operation result to be copied.

20. The electronic device of claim 18, wherein the broadcast control circuitry comprises comparison circuitry configured to output a respective destination index that matches a predetermined issue slot result port of the programmable processing array and a predetermined clock cycle delay.
